(19) United States
(12) Patent Application Publication
(10) Pub. No.: US 2025/0148061 A1
(43) Pub. Date: May 8, 2025

(54) SYSTEMS AND METHODS FOR PROVIDING A TRACKABLE DIGITAL ASSET AND ITS USE THEREOF

(71) Applicant: BB INVENTIONS INC., Varennes (CA)

(72) Inventor: Nathan Trudeau, Varennes (CA)

(21) Appl. No.: 18/691,151

(22) PCT Filed: Aug. 26, 2022
(86) PCT No.: PCT/IB2022/058014

§ 371 Date: Mar. 12, 2024

Related U.S. Application Data
(60) Provisional application No. 63/243,157, filed on Sep. 12, 2021.
(60) Provisional application No. 63/255,728, filed on Oct. 14, 2021.
(60) Provisional application No. 63/278,427, filed on Nov. 11, 2021.
(60) Provisional application No. 63/289,020, filed on Dec. 13, 2021.

(51) Int. Cl. G06F 21/16; G06F 21/60; G06Q 30/06

(52) U.S. Cl. CPC G06F 21/16; G06F 21/602; G06Q 30/06

(57) ABSTRACT

A method and a system are disclosed for providing a trackable digital asset. The method comprises obtaining a digital asset, embedding data suitable for identifying the digital asset in the digital asset to generate a trackable digital asset, obtaining at least one indication of at least one one-way cryptographic encryption of at least one portion of the trackable digital asset, encrypting, using a password, at least one portion of the trackable digital asset and providing at least one indication of at least the encrypted trackable digital asset. Authenticity of a given digital asset is determined by comparing the obtained at least one indication of the at least one one-way cryptographic encryption of the at least one portion of the trackable digital asset with at least one indication of at least one one-way cryptographic encryption of at least one portion of the given digital asset.

### CROSS-REFERENCE TO RELATED APPLICATIONS

This application is related to U.S. Provisional Patent Application No. 63/243,157 filed on Sep. 12, 2021; U.S. Provisional Patent Application No. 63/255,728 filed on Oct. 14, 2021; U.S. Provisional Patent Application No. 63/278,427 filed on Nov. 11, 2021; and U.S. Provisional Patent Application No. 63/289,020 filed on Dec. 13, 2021.

### TECHNICAL FIELD

This invention relates to digital assets. More precisely, one or more embodiments of the invention relate to a computer-implemented method and a system for providing a trackable digital asset.

### BACKGROUND OF THE ART

The market value of digital assets is increasing every year as they become more and more popular. Generally, a digital asset is a digital file which comes with rights of use and has an associated value. It will be appreciated that digital assets can be traded, for instance, in blockchains such as Ethereum™, FLOW™, Tezos™, Solana™, and the like, which advantageously allow to track record of ownership of the digital asset. Since ownership of a digital asset is limited to typically a single owner, a certain value can be associated to the digital asset which a buyer would have to trade for in order to acquire the ownership of the digital asset.

To ensure ownership of a digital asset, the latter is usually encrypted using cryptographic methods and contains information about the owner. Yet, such transactions usually limit the digital asset to a pure commodity, and the authenticity of the digital asset is not considered, due to a lack of traceability. For instance, one could simply copy a publicly available digital asset, mint the digital asset in a blockchain and sell the digital asset to a buyer without giving credit to the original creator and the previous owners of the digital asset. While being operational, such systems omit the authenticity aspect of the transaction of a digital asset, which is a serious drawback.

There is therefore a need for at least one of a method and a system that will overcome at least one of the above-identified drawbacks.

### SUMMARY

According to a broad aspect, there is disclosed a computer-implemented method for providing a trackable digital asset, the computer-implemented method comprising obtaining a digital asset, embedding data suitable for identifying the digital asset in at least one portion of the digital asset to generate the trackable digital asset, obtaining at least one indication of at least one one-way cryptographic encryption of at least one portion of the trackable digital asset, encrypting, using a password, at least one portion of the trackable digital asset and providing at least one indication of at least the encrypted at least one portion of the trackable digital asset, wherein authenticity of a given digital asset is determined by comparing the obtained at least one indication of the at least one one-way cryptographic encryption of the at least one portion of the trackable digital asset with at least one indication of at least one one-way cryptographic encryption of at least one portion of the given digital asset.

In accordance with one or more embodiments, the digital asset comprises at least one element, wherein each of the at least one element is selected from a group consisting of an image file, a video file, an audio file, a text document, binary data and a compressed archive.

In accordance with one or more embodiments, the embedding of the data in the at least one portion of the digital asset is performed by combining at least one portion of the data with at least a portion of the digital asset.

In accordance with one or more embodiments, the embedding of the data in the at least one portion of the digital asset is performed using at least one steganography technique.

In accordance with one or more embodiments, the at least one one-way cryptographic encryption of the at least one portion of the trackable digital asset is performed using at least one hashing technique.

In accordance with one or more embodiments, the encrypting of the at least one portion of the trackable digital asset is performed using one of an asymmetric encryption and a symmetric encryption.

In accordance with one or more embodiments, the obtaining of the at least one indication of the at least one one-way cryptographic encryption of the at least one portion of the trackable digital asset comprises obtaining a plurality of at least one indication of at least one one-way cryptographic encryptions, each associated with a corresponding portion of the trackable digital asset, wherein the authenticity of the given digital asset is determined by comparing the obtained plurality of at least one indication of at least one one-way cryptographic encryptions of the given digital asset with a corresponding plurality of at least one indication of at least one one-way cryptographic encryptions of the trackable digital asset.

In accordance with one or more embodiments, the providing of the at least one indication of at least the encrypted at least one portion of the trackable digital asset further comprises providing the obtained at least one indication of the at least one one-way cryptographic encryption of the at least one portion of the trackable digital asset.

In accordance with one or more embodiments, the providing of the at least one indication of at least the encrypted at least one portion of the trackable digital asset further comprises at least one of minting at least one of the at least one indication of at least the encrypted at least one portion of the trackable digital asset and the obtained at least one indication of the at least one one-way cryptographic encryption of the at least one portion of the trackable digital asset in a blockchain, and providing at least one of the at least one indication of at least the encrypted at least one portion of the trackable digital asset and the obtained at least one indication of the at least one one-way cryptographic encryption of the at least one portion of the trackable digital asset to at least one of a smart contract, a system manager, a server, a computing node, a processing device, a software and a storage device.

In accordance with one or more embodiments, the computer-implemented method for providing a trackable digital asset further comprises providing the obtained at least one indication of the at least one one-way cryptographic encryption of the trackable digital asset to at least one of a smart contract, a system manager, a server, a computing node, a processing device, a software and a storage device.

In accordance with one or more embodiments, at least one of said obtaining of the digital asset, the embedding of the data in the at least one portion of the digital asset, the obtaining of the at least one indication of the at least one one-way cryptographic encryption of the at least one portion of the trackable digital asset, the encrypting of the at least one portion of the trackable digital asset and the providing of the at least one indication of at least the encrypted at least one portion of the trackable digital asset is performed by at least one of a smart contract, a computing node, a server, a processing device, a software, a storage device and a system manager.

In accordance with one or more embodiments, at least one of the obtaining of the at least one indication of the at least one one-way cryptographic encryption of at least one portion of the trackable digital asset and the encrypting at least one portion of the trackable digital asset is performed on a totality of the trackable digital asset.

In accordance with one or more embodiments, the computer-implemented method for providing a trackable digital asset further comprises obtaining at least one thumbnail representing at least one of the digital asset and the trackable digital asset, and providing at least one indication of the obtained at least one thumbnail.

In accordance with one or more embodiments, the obtaining of the at least one thumbnail further comprises embedding additional data in at least one portion of the at least one thumbnail.

In accordance with one or more embodiments, the obtaining of the digital asset comprises digitalizing an asset.

In accordance with one or more embodiments, the providing of the at least one indication of at least the encrypted at least one portion of the trackable digital asset further comprises transforming the at least one indication of at least the encrypted at least one portion of the trackable digital asset into an encrypted trackable asset.

In accordance with one or more embodiments, the trackable digital asset is an encrypted trackable digital asset.

In accordance with one or more embodiments, the computer-implemented method for providing a trackable digital asset further comprises obtaining at least one identifier for identifying at least one given computing node, the at least one given computing node being associated with the encrypting of the at least one portion of the trackable digital asset, and obtaining an encrypted password using at least one portion of the obtained at least one identifier.

In accordance with one or more embodiments, the obtaining of the at least one identifier for identifying the at least one given computing node further comprises generating at least one portion of at least one recovery identifier associated with at least one portion of the obtained at least one identifier.

In accordance with one or more embodiments, the computer-implemented method for providing a trackable digital asset further comprises encrypting, using the password, the indication of at least the encrypted at least one portion of the trackable digital asset, and providing the encrypted indication of at least the encrypted at least one portion of the trackable digital asset. According to a broad aspect, there is disclosed a computer-implemented method for trading at least one of an ownership of and an access to the trackable digital asset between a buyer and a seller, the computer-implemented method comprising organizing a transaction between a buyer and a seller to purchase the at least one of the ownership of and the access to the trackable digital asset, and authenticating the trackable digital asset using the at least one indication of the at least one one-way cryptographic encryption of at least one portion of the trackable digital asset.

In accordance with one or more embodiments, the computer-implemented method for trading at least one of an ownership of and an access to the trackable digital asset between a buyer and a seller further comprises providing at least one asset to the seller.

In accordance with one or more embodiments, the providing of the password further comprises providing the password to at least one first computing node, and the providing of the at least one asset further comprises providing the at least one asset to at least one second computing node, wherein the at least one second computing node is configured for transferring the at least one asset from the buyer to the seller and the at least one first computing node is configured for transferring the password from the seller to the buyer once the at least one asset is received at the at least one second computing node and the password is received at the at least one first computing node.

In accordance with one or more embodiments, the at least one second computing node is the at least one first computing node.

According to a broad aspect, there is disclosed a computer-implemented method trading at least one of an ownership of and an access to the trackable digital asset between a buyer and a seller, the computer-implemented method comprising organizing a transaction between a buyer and a seller to purchase the at least one of the ownership of and the access to the trackable digital asset, and authenticating the trackable digital asset using the at least one indication of the at least one one-way cryptographic encryption of the at least one portion of the trackable digital asset.

In accordance with one or more embodiments, the computer-implemented method for trading at least one of an ownership of and an access to the trackable digital asset between a buyer and a seller further comprises providing at least one asset to the seller.

In accordance with one or more embodiments, the computer-implemented method for trading at least one of an ownership of and an access to the trackable digital asset further comprises providing an indication of the encrypted password and at least one of the at least one portion of the at least one identifier and the at least one portion of the at least one recovery identifier to the buyer.

In accordance with one or more embodiments, the providing of the indication of the encrypted password and at least one of the at least one portion of the at least one identifier and the at least one portion of the at least one recovery identifier further comprises providing the indication of the encrypted password and at least one of the at least one portion of the at least one identifier and the at least one portion of the at least one recovery identifier to at least one third computing node, and the providing of the at least one asset further comprises providing the at least one asset to at least one fourth computing node, wherein the at least one fourth computing node is configured for transferring the at least one asset from the buyer to the seller and the at least one third computing node is configured for transferring the indication of the encrypted password and at least one of the at least one portion of the at least one identifier and the at least one portion of the at least one recovery identifier from the seller to the buyer once the at least one asset is received at the at least one fourth computing node and the indication of the encrypted password and the at least one of the at least one portion of the at least one identifier and the at least one portion of the at least one recovery identifier are received at the at least one third computing node.

In accordance with one or more embodiments, the at least one fourth computing node is the at least one third computing node.

In accordance with one or more embodiments, one of the indication of the encrypted password and the at least one of the at least one portion of the at least one identifier and the at least one portion of the at least one recovery identifier is provided prior to the at least one asset being received at the at least one fourth computing node.

In accordance with one or more embodiments, the organizing of the transaction comprises one of organizing at least one of a bidding process, a buying process and an offering process to complete the transaction between the buyer and the seller and providing at least one condition to meet to complete the transaction between the buyer and the seller.

According to a broad aspect, there is disclosed a computer-implemented method for determining an authenticity of a given digital asset to authenticate, the computer-implemented method comprising obtaining the given digital asset to authenticate and the at least one indication of the at least one one-way cryptographic encryption of at least one portion of a trackable digital asset, obtaining at least one indication of at least one one-way cryptographic encryption of at least one portion of the given digital asset to authenticate, obtaining an indication of a comparison between the at least one indication of the at least one one-way cryptographic encryption of the at least one portion of the trackable digital asset and the obtained at least one indication of the at least one one-way cryptographic encryption of the at least one portion of the given digital asset to determine its authenticity, and providing the indication of the comparison.

According to a broad aspect, there is disclosed a computer-implemented method for updating at least one indication of a first encrypted trackable digital asset, the computer-implemented method comprising in response to a given event, obtaining and decrypting the first encrypted trackable digital asset using the password, encrypting at least one portion of the decrypted first encrypted at least one portion of the trackable digital asset using a second password, thereby generating a second encrypted trackable digital asset, providing at least one indication of the second encrypted trackable digital asset to at least one of a smart contract, a system manager, a server, a processing device, a software a storage device, a computing node and a blockchain, and updating the at least one indication of the first encrypted at least one portion of the trackable digital asset with the at least one indication of the second encrypted trackable digital asset.

In accordance with one or more embodiments, the computer-implemented method for updating at least one indication of a first encrypted trackable digital asset further comprises embedding data suitable for identifying the given event in at least one portion of at least one of the obtained and decrypted first encrypted at least one portion of the trackable digital asset, the second encrypted trackable digital asset, the at least one thumbnail and at least one thumbnail of a decrypted second encrypted trackable digital asset.

In accordance with one or more embodiments, the second password is the password.

In accordance with one or more embodiments, the providing of the at least one indication of the second encrypted trackable digital asset further comprises decrypting the second encrypted trackable digital asset and authenticating the decrypted second encrypted trackable digital asset.

In accordance with one or more embodiments, the decrypting the second encrypted trackable digital asset further comprises decrypting the encrypted password with at least one of the at least one portion of the at least one identifier and the at least one portion of the at least one recovery identifier.

According to a broad aspect, there is disclosed a computer-implemented method for updating at least one indication of a third encrypted trackable digital asset, the computer-implemented method comprising in response to a given event, obtaining the third encrypted trackable digital asset, embedding additional data suitable for identifying the given event in the third encrypted at least one portion of the trackable digital asset, thereby generating a fourth encrypted trackable digital asset, providing at least one indication of the fourth encrypted trackable digital asset to at least one of a smart contract, a system manager, a server, a processing device, a software a storage device, a computing node and a blockchain, and updating the at least one indication of the third encrypted at least one portion of the trackable digital asset with the at least one indication of the fourth encrypted trackable digital asset.

In accordance with one or more embodiments, the obtaining of the at least one indication of the at least one one-way cryptographic encryption of at least one portion of the trackable digital asset comprises generating the at least one indication of the at least one one-way cryptographic encryption of at least one portion of the trackable digital asset; and further wherein the authenticity of the given digital asset is determined by comparing the generated at least one indication of the at least one one-way cryptographic encryption of the at least one portion of the trackable digital asset with at least one indication of at least one one-way cryptographic encryption of at least one portion of the given digital asset.

In accordance with one or more embodiments, the providing of the at least one indication of at least the encrypted at least one portion of the trackable digital asset comprises providing at least the encrypted at least one portion of the trackable digital asset.

According to a broad aspect, there is disclosed a non-transitory computer readable medium for storing instructions that are executable by one or more processors and which when executed perform a method for providing a trackable digital asset, the method comprising obtaining a digital asset to be provided, embedding data suitable for identifying the digital asset in at least one portion of the digital asset to generate the trackable digital asset, obtaining at least one indication of at least one one-way cryptographic encryption of at least one portion of the trackable digital asset, encrypting, using a password, at least one portion of the trackable digital asset, and providing at least one indication of at least the encrypted at least one portion of the trackable digital asset, wherein authenticity of a given digital asset is achieved by comparing the obtained at least one indication of the at least one one-way cryptographic encryption of the at least one portion of the trackable digital asset with at least one indication of at least one one-way cryptographic encryption of at least one portion of the given digital asset.

According to a broad aspect, there is disclosed a computer comprising a central processing unit, a display device, a communication port, a memory unit comprising an application for providing a trackable digital asset, the application comprising instructions for obtaining a digital asset, instructions for embedding data suitable for identifying the digital asset in at least one portion of the digital asset to generate the trackable digital asset, instructions for obtaining at least one indication of at least one one-way cryptographic encryption of at least one portion of the trackable digital asset, instructions for encrypting, using a password, at least one portion of the trackable digital asset, and instructions for providing at least one indication of at least the encrypted at least one portion of the trackable digital asset, and a data bus for interconnecting the central processing unit, the display device, the communication port and the memory unit.

It will be appreciated that one or more embodiments of the methods and the systems disclosed are of great advantages for various purposes.

A first advantage of one or more embodiments of the methods and the systems disclosed herein is that the present technology enables preserving the authenticity of a digital asset when trading thereof, thus enabling the trading of digital assets similarly to the trading of physical assets, thereby adding value to the digital assets. For instance, a person purchasing a digital asset which is known to be authentic will tend to give a greater value to the digital asset than if the authenticity cannot be established or confirmed. Further, the fact that the digital asset is trackable encourages buyers and artists to join a system using trackable digital assets. Furthermore, knowing that a digital asset is authentic and that the digital asset has been indeed originally created by its creator prevent the trade of fraudulent digital assets.

A second advantage of one or more embodiments of the methods and the systems disclosed herein is that encrypting the trackable digital asset and/or the password to encrypt the trackable digital asset enables to secure a digital transfer while minimizing a risk of theft. In addition, because of data embedded in the digital asset and at least one one-way cryptographic encryption of at least one portion of the trackable digital asset, if at least one of the digital asset and the trackable digital asset is leaked by a buyer and/or a seller, malicious individuals will be unable to claim ownership of the at least one of the digital asset and the trackable digital asset.

A third advantage of one or more embodiments of the methods and the systems disclosed herein is that it is possible to track digital assets with the data embedded therein, thus possibly enabling imposing limitations on the use and trade of trackable digital assets, such as, and without being limited to, preventing the trackable digital assets to be stored in determined databases or prohibiting the trade of non-trackable digital assets and/or trackable digital assets in determined blockchains or marketplaces.

A fourth advantage of one or more embodiments of the methods and the systems disclosed herein is that it is possible to decrypt an encrypted trackable digital asset without a user having to remember a password that encrypts the trackable digital asset, since an identifier encrypting the password may be automatically used to recover the password and therefore enables to decrypt the encrypted trackable digital asset without having the user to provide the password, in accordance with one or more embodiment.

The skilled addressee will appreciate that the technology presented herein is not bound to any particular brand and/or label, whether already widely known or not. The skilled addressee will appreciate that a technology part of a system comprising and/or enabled by digital asset(s) is often labelled and/or branded to relate to transparency, attractiveness and/or understandability, which may help in a process of establishing trust, determining at least one incentive and/or engaging with the branded and/or the labelled technology in relation to a consumer. The technology presented herein may be referred to as NFTProtect (PA), ProtectArt (PA), DataProtect (DP), and/or any suitable brand and/or label per se. The skilled addressee will appreciate that the above-mentioned brands and/or labels may be associated with one or more other technology not related to the one presented herein. At least one of the above-mentioned brands and/or labels may still be considered as relevant for the branding and/or the labelling of the current technology.

### BRIEF DESCRIPTION OF THE DRAWINGS

Having thus generally described the nature of the invention, reference will now be made to the accompanying drawings, showing by way of illustration example embodiments thereof and in which:

FIG. 1 is a schematic diagram which illustrates a system for providing a trackable digital asset, in accordance with one or more embodiments;

FIG. 2 is a flowchart which illustrates a method for providing a trackable digital asset, in accordance with one or more embodiments;

FIG. 3 is a flowchart which illustrates a method for encrypting a password, in accordance with one or more embodiments;

FIG. 4 is a flowchart which illustrates a method for performing a transaction of a trackable digital asset, in accordance with one or more embodiments; and

FIG. 5 shows a schematic diagram of an electronic device which may be used in accordance with one or more non-limiting embodiments of the present technology.

### DETAILED DESCRIPTION

In the following description of the embodiments, references to the accompanying drawings are by way of illustration of an example by which one or more embodiments of the invention may be practiced.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment”, “one exemplary embodiment” and the like mean “one or more (but not all) embodiments of the disclosed invention(s)” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to,” unless expressly specified otherwise.

The terms “a”, “an” and “the” mean “one or more” unless expressly specified otherwise.

The term “plurality” means “two or more” unless expressly specified otherwise.

The term “herein” means “in the present application, including anything which may be incorporated by reference” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example” and thus do not limit the terms or phrases they explain.

The term “i.e.” and like terms mean “that is” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed technologies are widely applicable to numerous embodiments, as is readily apparent from the disclosure. One of ordinary skill in the art will recognize that the disclosed technologies may be practiced with various modifications and alterations, such as structural and logical modifications. Although particular features of the disclosed technologies may be described with reference to one or more particular embodiments and/or drawings, it should be understood that such features are not limited to usage in the one or more particular embodiments or drawings with reference to which they are described, unless expressly specified otherwise.

With all this in mind, one or more embodiments of the present invention are directed to a method and a system for providing a trackable digital asset and its use thereof.

One or more embodiments of the present invention will be described in detail hereinafter with reference to the drawings and specific embodiments.

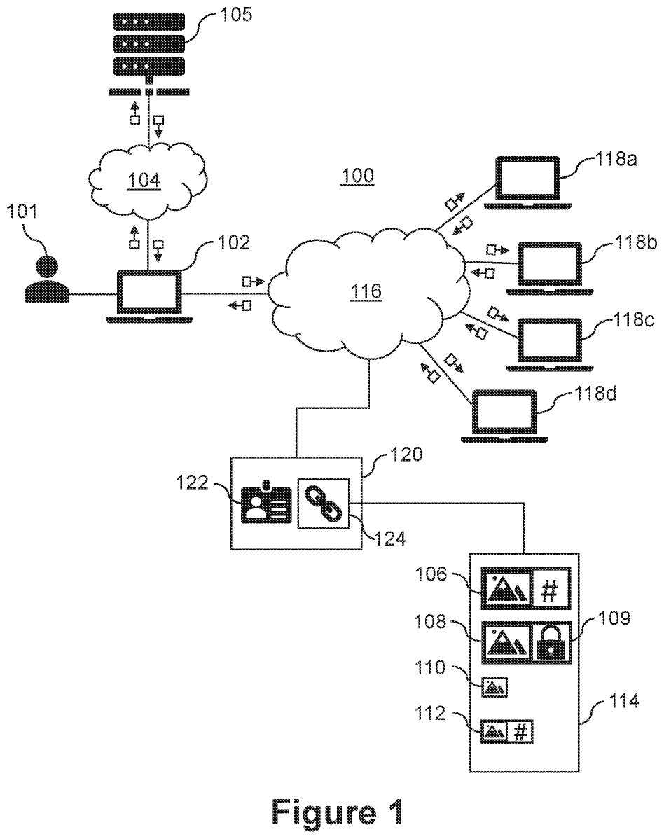

Now referring to FIG. 1, there is shown a communication system 100 for providing a trackable digital asset, which will be referred to as the system 100. The system 100 is suitable for implementing one or more non-limiting embodiments of the present technology.

It will be appreciated that the system 100 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a skilled addressee will understand, other modifications are likely possible. Further, where this has not been done (i.e., where no examples of modifications have been set forth), it should not be interpreted that no modifications are possible and/or that what is described is the sole manner of implementing that element of the present technology. As a skilled addressee will understand, this is likely not the case. In addition, it is to be understood that the system 100 may provide in certain instances simple implementations of the present technology, and that where such is the case they have been presented in this manner as an aid to understanding. As a skilled addressee will understand, various implementations of the present technology may be of a greater complexity.

The system 100 comprises a processing device 102 accessible to a user 101. In one or more embodiments, the processing device 102 is selected from a group consisting of computers, laptops, cellphones, smartphones, desktop computers, servers, tablets and the like. A more detailed description of one or more embodiments of a processing device is found further hereinbelow.

The skilled addressee will appreciate that the digital asset may be of various types. In one or more embodiments, the digital asset comprises at least one element. Each of the at least one element is selected from a group consisting of image files, video files, audio files, binary files and the like. As a matter of fact, it will be appreciated that the digital asset may be related to a non-fungible token (NFT) in one or more embodiments. In one or more embodiments, the digital asset is a text document, binary data or a non-art-related file. In one or more embodiments, the digital asset is selected from a group consisting of ZIP file, RAR file, TAR file, compressed archives and the like. In one or more embodiments, the digital asset comprises a plurality of files. In one or more embodiments, the digital asset consists of a portion or the entirety of the data stored in one or more computer. The skilled addressee will appreciate that various alternative embodiments may be possible for the digital asset.

In order to provide the trackable digital asset, data suitable for identifying the digital asset is embedded in the digital asset to thereby create a trackable digital asset. It will be appreciated that the identifying of the digital asset may comprise at least one of certifying and authenticating the digital asset.

It will be appreciated that the data suitable for identifying the digital asset may be of various types. For instance, and in one or more embodiment, the data may be personal information such as the user 101's name, the user 101's email address, a user 101's ID, the user 101's wallet number, information about at least one of a license, a company number, a user 101's marketplace credentials, an upload time, such as a timestamp, and the like, or any indication thereof. In one or more embodiments, the data comprises metadata suitable for identifying the digital asset. For instance, in one or more embodiments, the data comprises data certified by at least one of a company, a public certification agency, a private certification agency, at least one third party and the like.

It will be appreciated that the data suitable for identifying the digital asset may be provided according to various embodiments, and the present technology is not limited by the embodiments described herein. In one or more embodiments, the data is related to the title of the digital asset, the creation date and information related to the digital asset or the like.

It will be appreciated that the embedding of the data may be performed according to various embodiments. In one or more embodiments, the data is embedded by combining at least one portion of the data with at least one portion of the digital asset. The skilled addressee will appreciate that embedding data in the digital asset enables to keep a record of the authenticity of the digital asset, and enables the tracking of the digital asset.

It will be appreciated by the skilled addressee that the data suitable for identifying the digital asset may be embedded in the digital asset using various techniques. In fact, those embedding techniques may involve removing data in the digital asset or modifying the current data in the digital asset without augmenting the size of the digital asset. For instance, and in one or more embodiments, the embedding of the data suitable for identifying the digital asset in the digital asset is performed using at least one steganography technique known to the skilled addressee.

While in one or more embodiments, the data is embedded in a portion of the digital asset, it will be appreciated that in one or more other embodiments the data is embedded in the entirety of the digital asset.

In one or more embodiments, the processing device 102 is operatively connected to a server 105 via a communication network 104. As further disclosed below, it will be appreciated that the server 105 may perform at least one processing step of the method for providing a trackable digital asset.

The communication network 104 is used for transmitting data between the processing device 102 and the server 105. For example, the communication network 104 may be used to transmit requests from the processing device 102 to the server 105.

It will be appreciated that the communication network 104 may be of various types. In one or more embodiments, the communication network 104 comprises at least one of a local area network (LAN), a wide area network (WAN), a private communication network and the like. In one or more embodiments, the communication network 104 comprises the Internet.

It will be appreciated by the skilled addressee that the server 105 may be of various types. More precisely, and in one or more embodiments, the server 105 is implemented as a conventional computer server. In a non-limiting example of one or more embodiments of the present technology, the server 105 is implemented as a server running an operating system (OS). In the disclosed non-limiting embodiment, the server 105 is a single server. In one or more alternative embodiments, the functionality of the server 105 may be distributed and may be implemented via multiple servers (not depicted). In one or more embodiments, the server may be replaced by at least one of a user, a smart contract, a system manager, processing device, a software, a storage device and the like.

The server 105 comprises a communication interface (not depicted) configured to communicate with the processing device 102 via the communication network 104. The server 105 further comprises at least one computer processor operationally connected with the communication interface and configured to execute various processes described herein. It will be appreciated that the server 105 is an embodiment of a processing device. In another alternative embodiment, any suitable processing device may replace the server 105.

Before being provided, operations are performed on at least one portion of the trackable digital asset to create at least one one-way cryptographic encryption of at least one portion of the trackable digital asset 106. The skilled addressee will appreciate that the at least one one-way cryptographic encryption may be performed according to various embodiments. In one or more embodiments, the at least one one-way cryptographic encryption is selected in a group consisting of cyclic redundancy checks, checksums, universal hash functions, non-cryptographic hash functions, keyed cryptographic hash functions, unkeyed cryptographic hash functions and the like. In one or more embodiments, the at least one one-way cryptographic encryption is performed on the trackable digital asset.

It will be appreciated that the at least one one-way cryptographic encryption of at least one portion of the trackable digital asset 106 is provided as a means to assess the authenticity of at least one of the trackable digital asset and a given digital asset. The skilled addressee will appreciate that it is statistically impossible to reconstruct the at least one portion of the trackable digital asset from a one-way cryptographic encryption algorithm, thus validating the authenticity of at least one of a trackable digital asset and a given digital asset using at least one one-way cryptographic encryption is statistically a temper proof method. In one or more embodiments, the processing device 102 is one-way encrypting the trackable digital asset at least once. In one or more other embodiments, the processing device 102 is providing the trackable digital asset, for example via the communication network 104, to the server 105 and the latter is performing the at least one one-way cryptographic encryption of at least one portion of the trackable digital asset 106. In yet another embodiment, an indication of the at least one one-way cryptographic encryption of at least one portion of the trackable digital asset 106 is provided instead of the at least one one-way cryptographic encryption of at least one portion of the trackable digital asset 106. In yet another embodiment, the server 105 is providing a set of computer instructions via the communication network 104 to the processing device 102, the set of computer instructions allowing to one-way encrypt the trackable digital asset at least once on the processing device 102. In one or more embodiments, the trackable digital asset is directly provided to the server 105 without being provided to the processing device 102 in the first place. The skilled addressee will thus appreciate that the obtaining of the at least one one-way cryptographic encryption of at least one portion of the trackable digital asset 106 is not limited to the embodiments disclosed herein and that various alternative embodiments may be provided for providing the at least one one-way cryptographic encryption of at least one portion of the trackable digital asset 106.

As a matter of fact, it will be appreciated that in one or more embodiments, the at least one one-way cryptographic encryption is performed on at least one portion of the digital asset, and that an indication that data is embedded in the digital asset is provided along with the at least one one-way cryptographic encryption of the at least one portion of the digital asset 106. In one or more embodiments, an indication of the at least one one-way cryptographic encryption of at least one portion of the digital asset 106 is provided instead of the at least one one-way cryptographic encryption of the digital asset 106.

Still referring to FIG. 1, it will be appreciated that at least one portion of the trackable digital asset is encrypted using a password 109 to create an encrypted trackable digital asset 108. It will be appreciated that the encryption is one of a symmetric encryption algorithm and an asymmetric encryption algorithm.

It will be appreciated that the password 109 may be of various types. In one or more embodiments, the password 109 comprises a series of characters. In one or more embodiments, the password 109 the series of characters is known by the user 101. In one or more embodiments, the password comprises binary data.

The skilled addressee will further appreciate that the password 109 may be provided according to various embodiments. In one or more embodiments, an indication of the password or a fingerprint is provided along with or instead of the password or the fingerprint. In one embodiment, an indication of the encrypted trackable digital asset 108 may be provided instead of the encrypted trackable digital asset 108.

It will be appreciated that the encryption may be performed according to various embodiments. In one or more embodiments, the trackable digital asset is encrypted using a symmetric encryption algorithm selected from a group consisting of Advanced Encryption Standard (AES), Data Encryption Standard (DES), International Data Encryption Algorithm (IDEA), Blowfish, Rivest Cipher 4 (RC4), Rivest Cipher 5 (RC5), Rivest Cipher 6 (RC6) and the like. In one or more other embodiments, the trackable digital asset 106 is encrypted using an asymmetric encryption algorithm selected from a group consisting of Rivest Shamir Adleman (RSA), Digital Signature Standard (DSS), Digital Signature Algorithm (DSA), Elliptical Curve Cryptography (ECC), Diffie-Hellman Exchange Method, TLS/SSL Protocol and the like. The skilled addressee will appreciate that the trackable digital asset may be partially or fully encrypted. For instance, the trackable digital asset may be encrypted, while the embedded data may not be encrypted. In one or more embodiments, the trackable digital asset is an encrypted trackable digital asset.

In one or more embodiments, once the encrypted trackable digital asset 108 is obtained, the password 109 is stored in the processing device 102. In another embodiment, once the encrypted trackable digital asset 108 is obtained, the password 109 is stored in the server 105. It will be appreciated that it is statistically improbable to decrypt the encrypted trackable digital asset 108 without having access to the password 109.

In one or more embodiments, at least one portion of the password 109 is encrypted using the fingerprint associated with the processing device 102. In another embodiment, the password 109 is encrypted using at least an indication of the fingerprint associated with the processing device 102, for instance at least one one-way cryptographic encryption of at least one portion of the fingerprint of the processing device 102. The skilled addressee will appreciate that generating a fingerprint is an attempt to generate data that identifies a processing device, such as the processing device 102. The skilled addressee will thus appreciate that fingerprint generation techniques may fail in some instances to generate the fingerprint and multiple generations may be required for generating a correct fingerprint. In one or more embodiments, the fingerprint comprises a browser fingerprint collected by interacting with a web browser of the processing device 102. In one or more other embodiments, the fingerprint comprises at least one of a MAC address and an IP address of the processing device 102. In one or more embodiments, a plurality of fingerprints are generated to identify the processing device 102. The skilled addressee will appreciate that encrypting at least one of a file and the password 109 using the fingerprint of the processing device 102 ensures that at least one of the file and the password 109 is in the same environment as it was encrypted when decrypting at least one of the file and the password 109 using the fingerprint of at least one of the file's current environment and the password 109's current environment. Furthermore, encrypting at least one of the file and the password 109 using the fingerprint of the processing device 102 in which the environment of at least one of the file and the password 109 enables the storing of complex passwords in an altered form without relying on the memory of a user and without creating a potential major security risk by digitally storing the complex passwords in plain. In one or more embodiments, at least one of the file and the password 109 is provided in a binary data form. In one or more embodiments, at least one of the password and the fingerprint is provided using threshold signature schemes and the like. It will be appreciated that the fingerprint may be referred to as an identifier, in accordance with the embodiment.

In one or more embodiments, the data of the fingerprint used for encrypting at least one of the file and the password 109 is derived into a seed phrase (not depicted) provided to the user 101 or to the current owner of the trackable digital asset. In one or more embodiments, a plurality of owners own the trackable digital asset. In one or more embodiments, the seed phrase is encrypted using one of a symmetric encryption algorithm and an asymmetric encryption algorithm. In one or more embodiments, at least one portion of the seed phrase is encrypted using at least one one-way cryptographic encryption. It will be appreciated that a seed phrase may be derived from the fingerprint using a dictionary that matches at least one portion of the data of the fingerprint with words, characters, binary data or numbers. In one embodiment, the dictionary is BIP39. In one or more other embodiments, the seed phrase is an altered form of the fingerprint which is not associated with a dictionary. In the case where the fingerprint fails to decrypt the encrypted password 109, for instance where the algorithm generating the fingerprint fails to return the previously generated, thus correct, fingerprint, or if at least one of the encrypted password 109 and the encrypted file has been transferred to a different environment, the user is still able to decrypt at least one of the password 109 and the file by providing a seed phrase enabling the reconstruction of the correct fingerprint and the decryption of at least one of the encrypted password and the encrypted file. It will be appreciated that the abovementioned file is associated with the password 109. It will be further appreciated that the seed phrase may be referred to as a recovery identifier, in accordance with the embodiment.

In one or more embodiments, once the digital asset is embedded with data, at least one thumbnail 110 is obtained. It will be appreciated that each of the at least one thumbnail is representing at least one of the digital asset and the trackable digital asset. The skilled addressee will appreciate that each of the at least one thumbnail 110 is a representation of at least one of the digital asset and the trackable digital asset in an altered form and may be used for representing at least one of the digital asset and the trackable digital asset. The skilled addressee will appreciate that a thumbnail is a digital representation of a digital asset. The skilled addressee will also appreciate that the altered form may greatly vary depending on an embodiment. For instance, in one or more embodiments, the altered form is the result of at least one of using a lossy compression, applying a watermark, reducing the size of at least one of the digital asset and the trackable digital asset, removing at least one portion of at least one of the digital asset and the trackable digital asset, adding at least one representation of at least one portion of at least one of the digital asset and the trackable digital asset in a template and the like. In one or more embodiments, a plurality of thumbnails 110 are generated, which correspond to the plurality of files included in at least one of the trackable digital asset and the digital asset.

It will be appreciated that additional data may be embedded in at least one thumbnail. In one or more embodiments, an indication of at least one thumbnail 110 may be provided instead of the at least one thumbnail 110. The skilled addressee will appreciate that the at least one thumbnail 110 has no intrinsic value for the purpose of a transaction or a possession, since the content of the at least one thumbnail 110 is different from the one of the at least one of the trackable digital asset and the digital asset. Therefore, a result from at least one one-way cryptographic encryption of at least a portion of the at least one thumbnail 110 would be different than the at least one one-way cryptographic encryption of at least one portion of the trackable digital asset 106 thus invalidating an authentication of a transaction including and mainly revolving around the at least one thumbnail 110 of at least one of the digital asset and the trackable digital asset.

In one or more embodiments, an indication of the at least one thumbnail 112 is also generated for identifying the at least one thumbnail 110 without directly identifying at least one of the digital asset and the trackable digital asset. The skilled addressee will appreciate that the indication of the at least one thumbnail 112 may be provided according to various embodiments. In one or more embodiments, the indication of the at least one thumbnail 112 comprises an identification number thereof, at least one one-way cryptographic encryption of at least one portion thereof, a globally unique identifier, a binary data indication thereof and the like. In one or more embodiments, a plurality of indications of the at least one thumbnail 112 are generated, which may represent one or more portions or the entirety of the at least one thumbnail 110.

In one or more embodiments, the at least one one-way cryptographic encryption of at least one portion of the trackable digital asset 106, the encrypted trackable digital asset 108, the at least one thumbnail 110 and the indication of the at least one thumbnail 112 are comprised in a data group 114. The skilled addressee will therefore appreciate that the encrypted trackable digital asset 108 represents the digital asset in at least one of its trackable and non-trackable form. Further, the at least one one-way cryptographic encryption of at least one portion of the trackable digital asset 106 acts as a means of authenticate the trackable digital asset once decrypted. In one or more embodiments, the data group 114 only comprises the at least one one-way cryptographic encryption of the trackable digital asset 106 and the encrypted trackable digital asset 108. In one or more embodiments, at least part of the content of the data group 114 is stored in at least one of at least one of a centralized database and decentralized database. In another embodiment, the content of the data group 114 is distributed via a communication network 116 to a plurality of computing nodes 118a-d.

It will be appreciated that the data group 114 may contain various other information related to the trackable digital asset that is not presented herein.

In one or more embodiment, a token 120 comprising a token ID, an owner ID 122 and a URI 124 is accessible by at least one of the plurality of computing nodes 118a-d and the processing device 102. The skilled addressee will appreciate that the token 120 is generally a representation of the trackable digital asset on a blockchain that can be easily accessed across the plurality of computing nodes 118a-d.

It will be appreciated that the owner ID 122 comprises an indication of the identity of the current owner of the trackable digital asset. Thus, when trading the trackable digital asset, the owner ID 122 is modified to replace the identification of the identity of the seller with an indication the identity of the buyer.

In one or more embodiments, the token 120 comprises a plurality of owner ID 122 and/or a plurality of token ID.

It will also be appreciated that the URI 124 consists of an indication of the data group 114. In one or more embodiments, the URI 124 is an application programming interface (API) call over Hypertext Transfer Protocol Secure (HTTPS), an InterPlanetary File System (IPFS) hash and the like.

In one or more embodiment, the URI 124 replaces the data group 114 in the system 100.

The communication network 116 is used for transmitting data between the nodes 118a-d. For instance, the communication network 116 is used for transmitting requests or other information from one of the nodes 118a-d to another. It will also be appreciated that the communication network 116 may be used for transmitting information related to trackable digital assets, to cryptocurrencies, personal information and the like from at least one of the nodes 118a-d to at least one other. It will be appreciated that the number of nodes depicted in FIG. 1 is for exemplary purposes only, and that the number of nodes may greatly vary.

It will be appreciated by the skilled addressee that the communication network 116 may be of various types. In one or more embodiments, the communication network 116 comprises at least one of a local area network (LAN), a wide area network (WAN), a private communication network and the like. In one or more embodiments, the communication network 116 comprises the Internet.

In one or more embodiments, the server 105 processes at least one portion of the providing of the trackable digital asset. In another embodiment, at least one of a smart contract, a system manager, a server, a computing node, a processing device, a software and a storage device processes at least one portion of the providing of the trackable digital asset. It will be appreciated by the skilled addressee that a smart contract is a computer program which includes terms signed by at least one party. A smart contract may be centralized or decentralized, depending on an embodiment. In yet another embodiment, a plurality of computing nodes are, partially or as a whole, processing the providing of at least part of the trackable digital asset. In yet another embodiment, a system manager processes at least one portion of the providing of the trackable digital asset, the system manager being an entity that may own an authority overriding the rights of the user 101 and/or the processing device 102. The skilled addressee will thus appreciate that the user may or may not be involved in the providing of the trackable digital asset. It will be appreciated that the method for providing the trackable digital asset may consist of, inter alia, obtaining a digital asset, embedding data suitable for identifying the digital asset in the digital asset to generate a trackable digital asset, obtaining at least one indication of at least one one-way cryptographic encryption of at least one portion of the trackable digital asset, encrypting, using a password, at least one portion of the trackable digital asset, and providing at least one indication of the encrypted trackable digital asset.

It will be appreciated that the at least one indication of the encrypted trackable digital asset may be provided according to various embodiments. In one or more embodiments, the at least one indication of the encrypted trackable digital asset is minted into at least one blockchain. In one or more embodiment, at least one of the ownership of the trackable digital asset and access to the trackable digital asset is offered for sale on at least one of a digital marketplace and a physical marketplace. The skilled addressee will appreciate that a blockchain is one of a centralized and decentralized ledger shared by a plurality of nodes. It will be further appreciated that a marketplace is a space where digital assets are accessible to buyers. In one or more embodiments, the marketplace is a digital marketplace. In one or more other embodiments, the marketplace is a physical marketplace. In one or more embodiments, the marketplace has at least one thumbnail representative of at least one of the digital asset and the trackable digital asset. The skilled addressee will appreciate that at least one of the ownership of the trackable digital asset and access to the trackable digital asset may be offered for sale on a plurality of marketplaces. In one or more embodiments, the trackable digital asset is stored in one or more databases controlled by at least one of a user, a smart contract, a system manager, a server, a processing device, a software, a storage device and the like. It will be appreciated that the trackable digital assets may be provided for various uses.

It will be appreciated by the skilled addressee that an indication of a given element refer to any data enabling an identification of the given element. For instance, an indication of a given element may comprise identification data related to the given element, an encrypted version of the given element, at least one thumbnail of the given element, identification relating to a user related to the given element, any binary data related to the given element and the like. In one or more embodiments, the indication of the given element is the given element per se. In one embodiment, the indication of the given element is a Uniform Resource Locator (URL) or a similar reference to a digital resource.

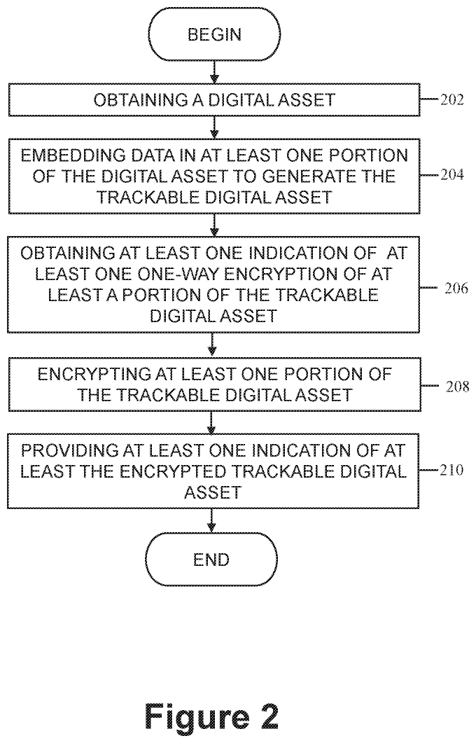

Now referring to FIG. 2, there is shown an embodiment of a method for providing a trackable digital asset.

According to processing step 202, a digital asset is obtained. It will be appreciated that the digital asset may be obtained according to various embodiments.

In one or more embodiments, the digital asset is obtained by at least one computing node of at least one user. In one or more other embodiments, the digital asset is obtained by at least one of a smart contract, a computing node, a server, a processing device, a software, a storage device and a system manager.

As already mentioned above, it will be appreciated that the digital asset may be of various types. For instance, and in one or more embodiments, the digital asset is selected from a group consisting of photo files, video files, audio files, binary data, compressed archives and the like. In one or more other embodiments, the digital asset is a text document or a non-art-related file.

Still referring to FIG. 2 and according to processing step 204, data suitable for identifying the digital asset is embedded in at least one portion of the digital asset to generate the trackable digital asset.

It will be appreciated that the data suitable for identifying the digital asset may be of various types. As mentioned above, and in one or more embodiments, the data may be personal information such as the user 101's name, the user 101's email address, the user 101's blockchain credentials, a user 101's ID, the user 101's wallet number, information about at least one of a license, a company number, a user 101 marketplace credentials, an upload time, such as a timestamp, and the like, or any indication thereof. In one or more embodiments, the data suitable for identifying the digital asset comprises metadata suitable for identifying the digital asset. For instance, in one or more embodiments, the data suitable for identifying the digital asset comprises data certified by a company, a public or a private certification agency, at least one third party and the like. In one or more embodiments, the data is related to the title of the digital asset, the creation date and information related to the digital asset or the like.

It will be appreciated that the data suitable for identifying the digital asset may be provided according to various embodiments.

As mentioned above, it will be appreciated that the embedding of the data may be performed according to various embodiments. In one or more embodiments, the data is embedded by concatenating at least one portion of the data with at least one portion of the digital asset. The skilled addressee will appreciate that embedding data in the digital asset enables to keep a record of the authenticity of the digital asset and enables the tracking of the digital asset.

It will be appreciated by the skilled addressee that the data suitable for identifying the digital asset may be embedded in the digital asset using various techniques. In fact, in one or more embodiment, the embedding technique may involve removing data in the digital asset or modifying the current data in the digital asset without augmenting the size of the digital asset. For instance, and in one or more embodiments, the embedding of the data suitable for identifying the digital asset in the digital asset is performed using at least one steganography technique known to the skilled addressee.

While in one or more embodiments the data is embedded in a portion of the digital asset, it will be appreciated that in one or more other embodiments the data is embedded in the totality of the digital asset.

Still referring to FIG. 2 and according to processing step 206, at least one indication of at least one one-way cryptographic encryption of at least one portion of the trackable digital asset is obtained.

It will be appreciated that the at least one one-way cryptographic encryption of at least one portion of the trackable digital asset provides a means for determining the authenticity of the trackable digital asset. The skilled addressee will appreciate that the at least one one-way cryptographic encryption may be performed according to various embodiments. In one or more embodiments, the at least one one-way cryptographic encryption is selected in a group consisting of cyclic redundancy checks, checksums, universal hash functions, non-cryptographic hash functions, keyed cryptographic hash functions, unkeyed cryptographic hash functions and the like. In one or more embodiments, the at least one one-way cryptographic encryption is performed on the trackable digital asset. The skilled addressee will further appreciate that portions of the trackable digital asset or an entirety thereof may be one-way encrypted depending on an embodiment. In one or more embodiments, the obtaining of the at least one indication of the at least one one-way cryptographic encryption of the at least one portion of the trackable digital asset is performed using at least one hashing method.

In one or more embodiments, the obtaining of the at least one indication of the at least one one-way cryptographic encryption of the at least one portion of the trackable digital asset comprises obtaining a plurality of indications of at least one one-way cryptographic encryption, each associated with a corresponding portion of the trackable digital asset. In such case, the authenticity of a given digital asset is determined by comparing an obtained plurality of indications of at least one one-way cryptographic encryption of the given digital asset, each associated with a corresponding portion of the given digital asset, with a corresponding plurality of indications of at least one one-way cryptographic encryption of the trackable digital asset, each associated with a corresponding portion of the trackable digital asset.

It will be appreciated that in one or more embodiments the obtaining of the at least one indication of the at least one one-way cryptographic encryption of the at least one portion of the trackable digital asset comprises performing the at least one one-way cryptographic encryption of the at least one portion of the trackable digital asset.

Still referring to FIG. 2 and according to processing step 208, at least one portion of the trackable digital asset is encrypted using a password. It will be appreciated that the encryption may be performed according to various embodiments as detailed above. It will be appreciated that at least one portion or the entirety of the trackable digital asset may be encrypted depending on an embodiment. In one or more embodiments, a plurality of passwords are used in parallel and/or in series with one another to encrypt at least a portion of the trackable digital asset.

Still referring to FIG. 2 and according to processing step 210, at least one indication of at least the encrypted trackable digital asset is provided. It will be appreciated that the at least one indication of at least the encrypted trackable digital asset may be provided according to various embodiments.

In one or more embodiments, the at least one one-way cryptographic encryption of at least one portion of the trackable digital asset is provided along with the encrypted trackable digital asset. In one or more embodiments, the at least one one-way cryptographic encryption of at least one portion of the trackable digital asset and the encrypted trackable digital asset are combined using XML format, such as JSON file format, or other suitable data formats.

In one or more embodiments, the providing of the at least one indication of at least the encrypted trackable digital asset comprises at least one of minting the at least one indication of the encrypted trackable digital asset and the obtained at least one indication of the at least one one-way cryptographic encryption of the at least one portion of the trackable digital asset in a blockchain and providing at least the at least one indication of the encrypted trackable digital asset to at least one of a smart contract, a system manager, a server, a computing node, a processing device, a software and a storage device.

The skilled addressee will appreciate that the blockchain in which the at least one indication of the encrypted trackable digital asset is minted may be of various types. It will be appreciated that the blockchain may be one of a public blockchain and a private blockchain. Once minted, the at least one indication of the encrypted trackable digital asset is available and the ownership thereof is established in the blockchain.

It will be appreciated that the at least one indication of at least the encrypted trackable digital asset may comprise the encrypted trackable digital asset per se. In other terms, the encrypted trackable digital asset may be provided.

Accordingly, it will be appreciated that in one or more embodiments the at least one indication of at least the encrypted trackable digital asset may be stored into one or more databases, storage devices and/or servers controlled by at least one of a user, a smart contract, a system manager, a server, a computing node, processing device, a software, a storage device and the like.

In fact, while in one or more embodiments a server may process at least one portion of the providing of the at least one indication of the encrypted trackable digital asset, it will be appreciated that in one or more other embodiments at least one smart contract may process at least one portion of the providing of the at least one indication of the encrypted trackable digital asset. In yet one or more other embodiments, a plurality of nodes are partially or as a whole processing the providing of the at least one indication of at least the encrypted trackable digital asset. In yet another embodiment, a system manager processes at least one portion of the providing of the at least one indication of the encrypted trackable digital asset. It will be therefore appreciated that the user may or may not be involved in the providing of the at least one indication of the encrypted trackable digital asset depending on an embodiment.

It will be appreciated that in one or more embodiments, the providing of the at least one indication of at least the encrypted trackable digital asset further comprises providing the obtained at least one indication of the at least one one-way cryptographic encryption of at least one portion of the trackable digital asset to at least one of a smart contract, a system manager, a server, a computing node, processing device, a software and a storage device.

In one or more embodiments, the method disclosed in FIG. 2 further comprises obtaining at least one identifier uniquely identifying at least one first computing node, the at least one first computing node being associated with the encrypting of at least one portion of the trackable digital asset and encrypting the password using the at least one identifier identifying the at least one first computing node. The skilled addressee will appreciate that the at least one identifier corresponds to a fingerprint, according to one or more embodiments. In one or more embodiment, the identifier is associated with at least one of a processing device and a process associated with a processing device.

In one or more embodiments, the obtaining of the at least one identifier identifying at least one first computing node further comprises generating at least one seed phrase associated with the at least one generated identifier.

In one or more embodiments, the method for providing a trackable digital asset further comprises obtaining at least one thumbnail representing at least one of the digital asset and the trackable digital asset and providing at least one indication of the obtained at least one thumbnail.

In one or more embodiments, the obtaining of the at least one thumbnail further comprises embedding additional data in at least one of the at least one thumbnail as disclosed above.

In one or more embodiments, the data group further comprises at least one of the at least one thumbnail and the at least one indication of the at least one thumbnail.

In one or more embodiments, the trackable digital asset is an encrypted trackable digital asset. The skilled addressee will appreciate that the method for providing a trackable digital asset described herein may be performed for a plurality of iterations, thus providing layers of encryption and data.

It will be appreciated that at least one of the processing steps disclosed in FIG. 2 may be performed by at least one of a smart contract, a computing node, a server, a processing device, a software, a storage device and a system manager.

In one or more embodiments of the method for providing a trackable digital asset, the obtaining of the at least one indication of the at least one one-way cryptographic encryption of the at least one portion of the trackable digital asset comprises creating the at least one indication of the at least one one-way cryptographic encryption of at least one portion of at least the trackable digital asset. The authenticity of the given digital asset is determined by comparing the created at least one indication of the at least one one-way cryptographic encryption of the at least one portion of the trackable digital asset with at least one indication of at least one one-way cryptographic encryption of at least one portion of the given digital asset.

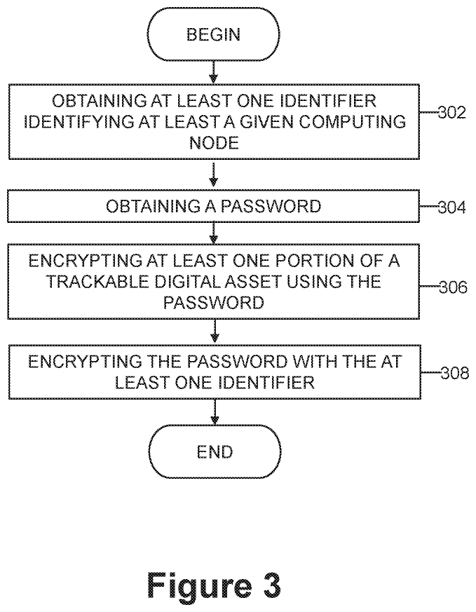

It will be appreciated that the encrypting of at least one portion of the trackable digital asset may be performed using an encrypted password in accordance with one or more embodiments. Now referring to FIG. 3, there is shown an embodiment of a method for encrypting a password.

According to processing step 302, an identifier identifying at least one first computing node is obtained.

It will be appreciated that the identifier may be of various types. For instance, the identifier may consist of a fingerprint of at least one processing device and may be generated using a fingerprinting algorithm. In one or more embodiments, the fingerprint is a browser fingerprint collected by interaction with the web browser of the at least one processing device. In another embodiment, the fingerprint comprises at least one indication of a MAC address and an IP address of the at least one processing device. The skilled addressee will appreciate that the identifier may be of various forms and may involve at least one authentication scheme. In one or more embodiments, the at least one authentication scheme involved for obtaining the identifier is selected from a group comprising multi-factor authentication, certificate-based authentication, biometric authentication, token-based authentication and the like. The skilled addressee will appreciate that the fingerprint may be any sort of data which enables to identify the at least one processing device or computer process, or, if applicable, its corresponding user.

Still referring to FIG. 3 and according to processing step 304, a password used for encrypting a trackable digital asset is obtained. It will be appreciated that the password may be obtained according to various embodiments. In one or more embodiments, the password comprises at least an indication of a seed phrase known by at least the owner of the trackable digital asset. In one or more embodiments, the seed phrase comprises the fingerprint. In one or more embodiments, more than one seed phrases are obtained and are related with a corresponding fingerprint. In one or more other embodiments, the seed phrase is at least one one-way cryptographic encryption of at least one portion of the fingerprint. In one or more embodiments, the password comprises a series of characters. In one or more embodiments, the password comprises binary data. In another embodiment, at least one of the password and the fingerprint is provided using threshold signature schemes and the like. The skilled addressee will appreciate that the password may be provided according to various embodiments.

According to processing step 306, at least one portion of the trackable digital asset is encrypted using the obtained password. It will be appreciated that the encryption may be performed according to various embodiments. In one or more embodiments, the at least one portion of the trackable digital asset is encrypted using a symmetric encryption algorithm selected from a group consisting of Advanced Encryption Standard (AES), Data Encryption Standard (DES), International Data Encryption Algorithm (IDEA), Blowfish, Rivest Cipher 4 (RC4), Rivest Cipher 5 (RC5), Rivest Cipher 6 (RC6) and the like. In one or more other embodiments, the at least one portion of the trackable digital asset is encrypted using an asymmetric encryption algorithm selected from a group consisting of Rivest Shamir Adleman (RSA), Digital Signature Standard (DSS), Digital Signature Algorithm (DSA), Elliptical Curve Cryptography (ECC), Diffie-Hellman Exchange Method, TLS/SSL Protocol and the like. The skilled addressee will appreciate that the trackable digital asset may be partially or fully encrypted depending on an embodiment. For instance, the trackable digital asset may be encrypted, while the embedded data may not be encrypted.

According to processing step 308, at least one portion of the password is encrypted with the generated identifier. In one or more embodiments, the generated identifier comprises a fingerprint. In one or more embodiments, the encryption is performed using one of a symmetric encryption and an asymmetric encryption. It will be appreciated that the encrypting of at least one portion of the password with the fingerprint may be similar to the encrypting of at least one portion of the trackable digital asset with the password of processing step 306, i.e., that at least one portion of the password can at least be decrypted or encrypted using an algorithm involving the fingerprint.

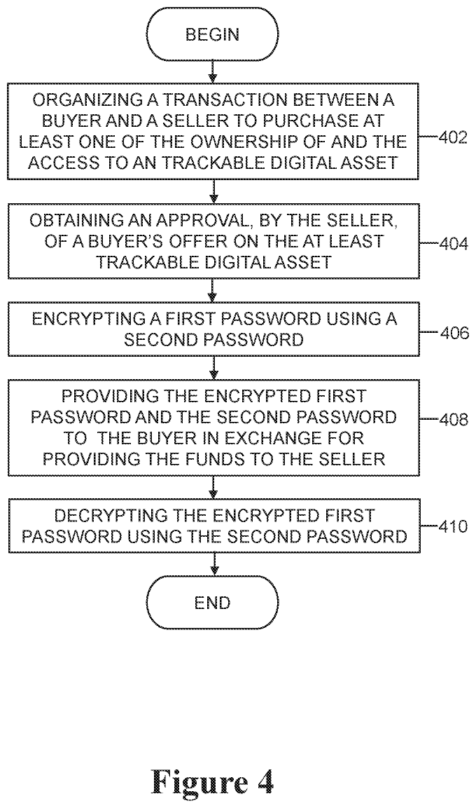

Now referring to FIG. 4, there is shown an embodiment of a method for performing a transaction with a trackable digital asset.

According to processing step 402, a transaction between a buyer and a seller to purchase at least one of the ownership of and the access to the trackable digital asset is organized. It will be appreciated that the trackable digital asset may be obtained or generated according to any of the embodiments disclosed above, and in particular in accordance with the method disclosed in FIG. 2 in one embodiment.

It will be appreciated that the transaction may be organized between a plurality of buyers and a plurality of sellers, for example in the case where a plurality of files are comprised in the trackable digital asset. In one or more embodiments, the transaction is organized in a marketplace, where at least an indication of at least one of the trackable digital asset, such as a thumbnail, and the digital asset is provided.

According to processing step 404, an approval of a buyer's offer on the trackable digital asset is obtained by the seller. The skilled addressee will appreciate that a transaction may not occur without obtaining the seller's approval of the provided offer in one or more embodiments. Yet, in one or more alternative embodiments, one of a system manager, a computing node and a smart contract may provide the seller's approval with or without the seller's consent.

Still referring to FIG. 4 and according to processing step 406, at least one portion of a first password is encrypted using at least one portion of a second password to obtain an encrypted first password. The first password enables the decryption of the trackable digital asset. It will be appreciated that the encryption of the at least one portion of the first password with the at least one portion of the second password is performed using one of a symmetric encryption and an asymmetric encryption. It will be appreciated that in one or more embodiments, processing step 406 may be recursively performed, i.e., a plurality of passwords may be obtained to encrypt at least one portion of each other. In one or more embodiments, a plurality of passwords are obtained for encrypting a plurality of portions of the trackable digital asset. In one or more embodiments, the second password is the identifier of at least the seller's computing node, the identifier being associated with at least one seed phrase. In one or more embodiments, a plurality of fingerprints and/or a plurality of seed phrases are provided.

Still referring to FIG. 4 and according to processing step 408, the encrypted first password and the at least one portion of the second password are provided to the buyer in exchange for providing at least one asset, an embodiment of which is a determined amount of funds, to the seller. It will be appreciated that once the encrypted first password and the at least one portion of the second password are provided to the buyer, the buyer has access to the trackable digital asset. In one or more embodiments, the buyer retrieves the trackable digital asset directly from the marketplace. In one or more other embodiments, the trackable digital asset is made available to the buyer by one of the seller, a server, a computing node, a smart contract, a system manager, a processing device, a software, a storage device and the like. The skilled addressee will appreciate that various alternative embodiments may be provided for providing the encrypted first password and the at least one portion of the second password.

In one or more embodiments, at least one of the ownership of and access to the trackable digital asset is provided to the buyer during processing step 408.

Still referring to FIG. 4 and according to processing step 410, the encrypted first password is decrypted using the at least one portion of the second password. The skilled addressee will appreciate that the trading of the trackable digital asset is completed once the at least one asset is received by the seller and the trackable digital asset is obtained by the buyer. In one or more embodiments, at least one portion of the obtained trackable digital asset is one-way encrypted at least once and is compared with at least one one-way cryptographic encryption of at least one portion of the decrypted trackable digital asset available on the marketplace in order to establish the authenticity of the traded trackable digital asset.

More broadly, it will be appreciated that the method for trading a trackable digital asset between a buyer and a seller may comprise organizing a transaction between the buyer and the seller to purchase at least one of the ownership of and the access to the at least one indication of the trackable digital asset and authenticating the trackable digital asset using at least the at least one indication of the at least one one-way cryptographic encryption of at least one portion of the trackable digital asset and providing the password to the buyer in exchange for providing at least one asset.

In one or more embodiments, the organizing of the transaction comprises one of organizing one of a bidding process, a buying process, a trading process and an offering process to complete the transaction between the buyer and the seller and providing at least one condition to meet to complete the transaction between the buyer and the seller.

In the case where a bidding process or a private offering system is organized, multiple users may offer payments to the seller, and, once a determined event occurs, a suitable offer for the at least one of the ownership of the trackable digital asset and access to the trackable digital asset may be selected or not by the seller.

In one or more other embodiments, the organizing of the transaction comprises creating a direct offer in a marketplace. The seller may accept and thus proceed with the transaction if at least one condition to meet to complete the transaction is met.

In one or more other embodiments, the buyer may contact the seller directly or indirectly to organize the transaction by offering at least one asset to the seller in exchange for at least being able to access the trackable digital asset.

In one or more other embodiments, the seller may contact the buyer directly or indirectly to organize the transaction by requiring at least one asset to be provided by the buyer in exchange for at least being able to access the trackable digital asset and/or any data related to at least one of the digital asset and the trackable digital asset.

In one embodiment, the method of FIG. 4 further comprises the step of providing the first password to a third computing node and the at least one asset to a fourth computing node, the fourth computing node being configured for transferring the at least one asset from the buyer to the seller and the third computing node being configured for transferring at least one password from the seller to the buyer. In one exemplary embodiment, the third computing node is the fourth computing node.

In one embodiment, the at least one asset is provided directly from a buyer's wallet to a seller's wallet.

In one or more embodiments, the encrypted first password is provided to the buyer via a first communication network and the at least one portion of the second password is provided to the buyer via a second communication network.

In one or more embodiments, the second communication network is the first communication network.

In one or more embodiments, the first password is not encrypted.

In one or more embodiments, the first communication network and the second communication networks comprise the Internet. In one or more alternative embodiments, the first communication network and the second communication network are selected from a group comprising at least one of a local area network (LAN), a wide area network (WAN), a private communication network and the like. In one or more embodiments, the first communication network and the second communication network are selected from a group consisting of emails, short message service (SMS) messages, encrypted communications and the like. The skilled addressee will appreciate that the first communication network and the second communication network may be different in order to minimize the risks of intercepting or eavesdropping both passwords by a malicious entity.

It will be appreciated that there is also disclosed a method for determining an authenticity of a given digital asset to authenticate.

According to a first processing step, the given digital asset to authenticate and the at least one indication of the at least one one-way cryptographic encryption of at least one portion of a trackable digital asset are obtained. It will be appreciated that the at least one indication of the at least one one-way cryptographic encryption of at least one portion of a trackable digital asset is obtained according to one or more embodiments of the method disclosed above.

According to a second processing step, at least one indication of at least one one-way cryptographic encryption of at least one portion of the given digital asset to authenticate is obtained.

According to a third processing step, an indication of a comparison between the at least one one-way cryptographic encryption of the at least one portion of the trackable digital asset and the obtained at least one one-way cryptographic encryption of the at least one portion of the given digital asset to determine its authenticity is obtained.

The skilled addressee will appreciate that the comparing may be processed by performing a hash comparison between the at least one one-way cryptographic encryption of the at least one portion of the trackable digital asset and the at least one one-way cryptographic encryption of the at least one portion of the given digital asset. In the case where the hash comparison succeeds, the given digital asset is determined to be authentic. In the case where the hash comparison fails, the given digital asset is determined to be unauthentic.

According to a fourth processing step, the indication of the comparison is provided. In one or more embodiments, the obtaining of the digital asset comprises digitalizing an asset. For instance, an asset, such as a painting or a book, may be physically provided and digitalized, thereby creating a corresponding digital asset. In one or more embodiments, the providing of the encrypted trackable digital asset further comprises transforming the encrypted trackable digital asset into a trackable asset, such as by printing, 3D printing and the like.

The skilled addressee will appreciate that an asset may be obtained in the form of a photography, a painting, a written or printed document and the like. In one or more embodiments, the asset may be obtained in the form of a quick response (QR) code, a magnetic storage, a barcode and other types of encrypted assets known by the skilled addressee. For instance, an encrypted trackable asset may be digitalized, decrypted digitally and authenticated by validating the data embedded in the asset. Thus, the scope defined herein is not limited by the presented embodiments, and various applications may be derived from the current technology.

In one or more embodiments, the obtaining of the at least one one-way cryptographic encryption of at least one portion of the trackable digital asset comprises generating the at least one one-way cryptographic encryption of at least one portion of the trackable digital asset. In such one or more embodiments, authenticity of the given digital asset is determined by comparing the generated at least one one-way cryptographic encryption of the at least one portion of the trackable digital asset with at least one one-way cryptographic encryption of at least one portion of the given digital asset.

### Example A: Method for Trading a Trackable Digital Asset Using Cryptocurrency

Hereinbelow is disclosed an exemplary embodiment of a method for trading a trackable digital asset.
According to processing step A1, a buyer sends an offer to a seller for purchasing an trackable digital asset in a first defined cryptocurrency and specifies a minimum price.
According to processing step A2, the seller accepts the offer of the buyer and chooses a second defined cryptocurrency to be received.
According to processing step A3, the seller decrypts and sends a first password to a first server, the first password being used for decrypting the trackable digital asset once encrypted. In one or more embodiments, the first password is encrypted using a fingerprint associated with a seed phrase.
According to processing step A4, the first server encrypts the first password with at least one portion of a second password. In one embodiment, the second password is randomly generated. In one or more embodiments, the first password is encrypted using at least one portion of a fingerprint associated with at least one portion of a seed phrase.
According to processing step A5, a second server detects that the transaction is ready to process. In one embodiment, the second server is the first server.
According to processing step A6, the second server instructs a first cryptocurrency exchange to obtain a first wallet to be associated with the buyer to obtain at least one asset in the first defined cryptocurrency.
According to processing step A7, the buyer provides the at least one asset to the first wallet.
According to processing step A8, the second server detects that the at least one asset is received in the first wallet, and instructs the seller to transfer at least one of the at least one indication of the trackable digital asset, the at least one one-way cryptographic encryption of at least one portion of the trackable digital asset and the thumbnail of at least one of the digital asset and the trackable digital asset to the buyer. In one embodiment, the transfer is made to a third party before being transferred to the buyer. In one embodiment, the trackable digital asset is not transferred, but instead only changes with respect to at least one of the ownership of and the access to the trackable digital asset.
According to processing step A9, once the transfer of the trackable digital asset is completed or is almost completed, the second server instructs the first cryptocurrency exchange to transfer and potentially convert at least one asset taken from one or more cryptocurrency wallets in the second defined cryptocurrency. In one embodiment, the trackable digital asset is not digitally and/or physically transferred, but instead only at least one of the ownership of and the access to the trackable digital asset is provided to the buyer. In one or more embodiments, the second defined cryptocurrency is the same as the first defined cryptocurrency, and no cryptocurrency conversion occurs in the process.
According to processing step A10, the second server instructs the first cryptocurrency exchange to transfer at least one second defined asset to a second wallet associated with the seller.
According to processing step A11, the second server instructs the first cryptocurrency exchange to transfer at least one first defined asset from the first wallet to a second cryptocurrency exchange. It will be appreciated that the at least one first defined asset corresponds to the value of the at least one asset transferred and potentially converted at processing step A9. In one embodiment, the second cryptocurrency exchange is the first cryptocurrency exchange.
According to processing step A12, the second server instructs the first server to provide at least one of the encrypted first password, the at least one portion of the fingerprint and the at least one portion of the seed phrase to the buyer via a first means of communication.
According to processing step A13, the second server instructs the first server to provide the at least one portion of the second password to the buyer via a second means of communication. In one embodiment, the second means of communication is the first means of communication.
According to processing step A14, the buyer decrypts the first password using the at least one portion of the second password, and buyer has now at least access to the trackable digital asset.
In one or more embodiments, processing step A14 is processed prior to processing step A12.

### Example B: Method for Trading a Trackable Digital Asset Using Fiat Currency

Hereinbelow is disclosed an exemplary embodiment of a method for trading a trackable digital asset.
According to processing step B1, a buyer sends an offer to a seller for purchasing an trackable digital asset in a first defined cryptocurrency and specifies the minimum price.
According to processing step B2, the seller accepts the offer of the buyer and specifies that the at least one asset will be received in fiat currency.
According to processing step B3, the seller decrypts and sends a first password to a first server, the first password being used for decrypting the trackable digital asset once encrypted. In one or more embodiments, the first password is encrypted using a fingerprint associated with a seed phrase.
According to processing step B4, the first server encrypts the first password with at least one portion of a second password. In one embodiment, the second password is randomly generated. In one or more embodiments, the second password is encrypted using at least one portion of fingerprint associated with at least one portion of seed phrase.
According to processing step B5, a second server notices that the transaction is ready to process. In one embodiment, the second server is the first server.
According to processing step B6, the second server instructs a first cryptocurrency exchange to create a first wallet associated with the buyer to obtain at least one asset in the first defined cryptocurrency.
According to processing step B7, the buyer provides the at least one asset to the first wallet.
According to processing step B8, the second server detects that the at least one asset is received in the first wallet, and instructs the seller to transfer at least one of the at least one indication of the trackable digital asset, the at least one one-way cryptographic encryption of at least one portion of the trackable digital asset and the thumbnail of at least one of the digital asset and the trackable digital asset to the buyer. In one embodiment, the transfer is made to a third party before being transferred to the buyer. In one embodiment, the trackable digital asset is not transferred, but instead only changes with respect to at least one of the ownership of and the access to the trackable digital asset.
According to processing step B9, once the transfer of the trackable digital asset is completed or is almost completed, the second server instructs a first cryptocurrency exchange to provide at least one asset taken from one or more cryptocurrency wallets to an escrow. In one embodiment, the escrow is at least one of a smart contract, a system manager, a server, a computing node, a processing device, a software and a storage device.
According to processing step B10, the second server instructs the escrow to transfer at least one defined asset to the seller. In one embodiment, the at least one defined asset transfer is processed via a digital dollar exchange.
According to processing step B11, the second server instructs the first cryptocurrency exchange to transfers the first defined cryptocurrency from the first wallet to the second cryptocurrency exchange. It will be understood that the at least one first defined cryptocurrency value corresponds to up to the value of the at least one asset provided at processing step B9.
According to processing step B12, the second server instructs the first server to provide at least one of the encrypted first password, the at least one portion of the fingerprint and the at least one portion of the seed phrase to the buyer via a first means of communication.
According to processing step B13, the second server instructs the first server to provide the at least one portion of the second password to the buyer via a second means of communication. In one embodiment, the second means of communication is the first means of communication.
According to processing step B14, the buyer decrypts the first password using the at least one portion of the second password and the buyer has now at least access to the trackable digital asset.

In one or more embodiments, processing step B14 is processed prior to processing step B12.

### Example C: Method for Trading a Trackable Digital Asset Using Credit Cards

Hereinbelow is disclosed an exemplary embodiment (not depicted) of a method for trading a trackable digital asset.
According to processing step C1, a buyer sends an offer to a seller for purchasing an trackable digital asset in a fiat currency and specifies a minimum price.
According to processing step C2, the seller accepts the offer of the buyer and specifies that the at least one asset will be received in fiat currency.
According to processing step C3, the seller decrypts and sends a first password to a first server, the first password being used for decrypting the trackable digital asset once encrypted. In one or more embodiments, the first password is encrypted using a fingerprint associated with a seed phrase.
According to processing step C4, the first server encrypts the first password with at least one portion of a second password. In one embodiment, the second password is randomly generated. In one or more embodiments, the second password is encrypted using at least one portion of a fingerprint associated with at least one portion of a seed phrase.
According to processing step C5, a second server notices that the transaction is ready to process. In one embodiment, the second server is the first server.
According to processing step C6, the buyer provides at least one asset with a credit card to a credit institution. In one embodiment, the credit card transaction is processed using a credit card provider and further sent to a bank account.
According to processing step C7, the second server detects that the at least one asset is received at the credit institution or receive at least an indication of a confirmation from the credit institution, and instructs the seller to transfer at least one of the at least one indication of the trackable digital asset, the at least one one-way cryptographic encryption of at least one portion of the trackable digital asset, and the thumbnail of at least one of the digital asset and the trackable digital asset to the buyer. In one embodiment, the transfer is made to a third party before being transferred to the buyer. In one embodiment, the trackable digital asset is not transferred, but instead only changes with respect to at least one of the ownership of and the access to the trackable digital asset.
According to processing step C8, once the transfer of the trackable digital asset is completed or is almost completed, the second server instructs a first cryptocurrency exchange to provide at least one asset to an escrow. It will be appreciated that the provided at least one asset corresponds up to the at least one asset provided to the credit institution.
According to processing step C9, the second server instructs the escrow to transfer at least one asset to the seller. In one embodiment, the at least one asset transfer is processed by an automated clearing house (ACH) network. In another embodiment, the at least one asset transfer is processed via bank transfer, Interac and the like.
According to processing step C10, the second server instructs the first server to provide at least one of the encrypted first password, the at least one portion of the fingerprint and the at least one portion of the seed phrase to the buyer via a first means of communication.
According to processing step C11, the second server instructs the first server to provide the at least one portion of the second password to the buyer via a second means of communication. In one embodiment, the second means of communication is the first means of communication.
According to processing step C12, the buyer decrypts the first password using the at least one portion of the second password, and buyer has now at least access to the trackable digital asset.
In one or more embodiments, processing step C12 is processed prior to processing step C10.

With regard to the methods for trading a digital asset, the skilled addressee will appreciate that a reward may be attributed to at least one party involved in the trade. In one or more embodiments, at least one of the seller, the buyer, at least one server involved in the trade and the like receives a reward. The reward may be, but is not limited to, a fiat currency amount, a quantity of cryptocurrencies, one or more assets, granted rights in a blockchain and the like. In one or more embodiments, the at least one asset received by the seller is different from what is described in the transaction offer, due to various fees in the process, such as gas fees, wire fees, usage fees and the like. In one embodiment, the seller receives a reward upon involvement in a transaction.

In one or more embodiments, the at least one asset is provided in the form of any given asset, such as for instance a digital asset, a wire fee, a quantity of cryptocurrencies, permissions in a blockchain and the like. The skilled addressee will thus appreciate that the type of the at least one asset is not limited by the embodiments disclosed herein.

In one or more embodiments, the trading of the digital asset does not involve funds or any given asset in exchange for the trackable digital asset, as the seller provides for free the trackable digital asset to the buyer. In one or more embodiments, the seller provides funds or any given asset to the buyer along with the trackable digital asset. It will be appreciated that providing the trackable digital asset may comprise transferring the trackable digital asset to the buyer, as long as the buyer is the new owner or has access to the trackable digital asset.

### Example D: Method for Trading a Trackable Digital Asset

Hereinbelow is disclosed an exemplary embodiment of a method for trading a trackable digital asset.
According to processing step D1, a seller creates a first offer for a trackable digital asset in a marketplace and specifies the minimum price.
According to processing step D2, a buyer provides, in a first cryptocurrency, a second offer to the seller for the trackable digital asset, with a price at least equal to the minimum price defined by the seller.
According to processing step D3, the seller accepts the second offer in a second cryptocurrency. In one or more embodiments, the second cryptocurrency is similar to the first cryptocurrency.
According to processing step D4, the seller provides a first encrypted first password and a seller identifier to a first server that has access to an encrypted version of the trackable digital asset.
According to processing step D5, the first server attempts to decrypt the encrypted trackable digital asset using a decrypted first encrypted first password, the decrypted first encrypted first password being decrypted using the seller identifier. If the decrypted first encrypted first password fails to decrypt the encrypted trackable digital asset, the first server requests from the seller a first recovery identifier therefrom and reattempts to decrypt the encrypted trackable digital asset using the decrypted first encrypted first password, the decrypted first encrypted first password being decrypted using the first recovery identifier.
According to processing step D6, a second server obtains a second password and a related second recovery identifier, and encrypts the decrypted first encrypted first password using the second password, thereby obtaining a second encrypted first password. In one or more embodiments, the second password is randomly generated. In one or more embodiments, the second server is the first server.
According to processing step D7, the buyer receives the second recovery identifier via a first means of communication.
According to processing step D8, the buyer transfers at least one asset in the first cryptocurrency to a third server. In one or more embodiments, the third server is the first server and/or the second server.
According to processing step D9, the first server is informed that the third server has received the at least one asset in the first cryptocurrency and requests the seller to transfer at least one of an ownership of and an access to the trackable digital asset to the buyer.
According to processing step D10, the first server is informed that the at least one of an ownership of and access to the trackable digital asset has been transferred to the buyer and acquires the at least one asset in the first cryptocurrency from the second server.
According to processing step D11, the first server converts the at least one asset in the first cryptocurrency into a defined asset according to the second defined cryptocurrency.
According to processing step D12, the first server provides the second encrypted first password to the buyer via a second means of communication and the defined asset to the seller. In one or more embodiments, the second means of communication is the first means of communication
According to processing step D13, the buyer decrypts the second encrypted first password using the second recovery identifier.
According to processing step D14, the buyer encrypts the decrypted second encrypted first password using a buyer identifier.

### Example E: Method for Updating an Encrypted Trackable Digital Asset

Hereinbelow is disclosed an exemplary embodiment of a method for updating an encrypted trackable digital asset. The skilled addressee will appreciate that the updating of the encrypted trackable digital asset is performed in response to a given event. In one or more embodiments, the given event is selected from a group consisting of a transaction related to the encrypted trackable digital asset, a determined amount of time which has elapsed since the last given event, a request from at least one of a smart contract, a computing node, a processing device, a software, a storage device, a system manager, a request from a user and the like.
According to processing step E1, a trackable digital asset current owner decrypts a first encrypted trackable digital asset using a first password.
According to processing step E2, the current owner obtains a second password.
According to processing step E3, the current owner provides the second password to at least one of a user, a computing node, a smart contract, a system manager, a processing device, a storage device, a software and the like.
According to processing step E4, the current owner provides a second encrypted trackable digital asset encrypted using the second password to at least one of a smart contract, a computing node, a system manager, a processing device, a storage device and the like.
According to processing step E5, the second encrypted trackable digital asset is decrypted using the second password.
According to processing step E6, the trackable digital asset is authenticated.
According to processing step E7, upon authentication of the trackable digital asset, the at least one of a smart contract, a computing node, a system manager, a storage device and the like is informed that the trackable digital asset is authentic.
According to processing step E8, the first encrypted trackable digital asset is replaced by the second encrypted trackable digital asset.

### Example F: Method for Updating an Encrypted Trackable Digital Asset

Hereinbelow is disclosed an exemplary embodiment of a method for updating an encrypted trackable digital asset. The skilled addressee will appreciate that the updating of the encrypted trackable digital asset is performed in response to a given event. In one or more embodiments, the given event is selected from a group consisting of a transaction related to the encrypted trackable digital asset, a determined amount of time which has elapsed since the last given event, a request from at least one of a smart contract, a computing node, a system manager, a processing device, a software, a storing device, a request from a user and the like.
According to processing step F1, a defined user decrypts a first encrypted trackable digital asset using a first password. In one embodiment, the defined user is a previous owner of the first encrypted trackable digital asset.
According to processing step F2, the user obtains a second password.
According to processing step F3, the user provides the second password to a current owner.
According to processing step F4, the user provides a second encrypted trackable digital asset encrypted using the second password to at least one of a smart contract, a computing node, a system manager, a processing device, a software, a storage device and the like.
According to processing step F5, the current owner decrypts the second encrypted trackable digital asset using the second password.
According to processing step F6, the current owner authenticates the digital asset.
According to processing step F7, upon authentication of the trackable digital asset, the at least one of a smart contract, a computing node, a system manager, a storage device and the like is informed that the trackable digital asset is authentic.
According to processing step F8, the first encrypted trackable digital asset is replaced by the second encrypted trackable digital asset.

The skilled addressee will appreciate that the above described methods for trading a trackable digital asset and updating an encrypted trackable digital asset using the present technology may vary according to an embodiment.

In one or more embodiments of a method for updating an encrypted trackable digital asset, data is embedded in at least one of the decrypted first encrypted trackable digital asset, the first encrypted trackable digital asset, the second encrypted trackable digital asset, at least one thumbnail of the second trackable digital asset, at least one thumbnail of the second digital asset, at least one thumbnail of the first digital asset and at least one thumbnail of the first trackable digital asset, the data being provided according to the abovementioned embodiments. In one or more embodiments of a method for updating an encrypted trackable digital asset, the at least one indication of the at least one one-way cryptographic encryption of the at least one portion of the trackable digital asset is further updated along with the encrypted trackable digital asset. In one embodiment, the at least one thumbnail of at least one of the trackable digital asset and the digital asset is updated with data when updating the encrypted trackable digital asset.

In one or more embodiments of the above-presented method for updating the encrypted trackable digital asset, the latter is not decrypted during the processing of the method, as data may be added, removed or modified directly on the encrypted trackable digital asset.

In one or more embodiments, the updating is performed on the token by modifying the content of either the owner ID or the URI, or both. In one or more embodiments, the updating is performed on the data group by modifying the content of at least one of the encrypted trackable digital asset, the one-way cryptographic encryption of the trackable digital asset, the thumbnail of at least one of the trackable digital asset and the digital asset and the one-way encrypted thumbnail of at least one of the trackable digital asset and the digital asset. In one or more embodiments, the updating is performed on both the token and the data group.

There is also disclosed a method for updating at least one indication of a first encrypted trackable digital asset. The method comprises, in response to a given event, obtaining and decrypting the first encrypted trackable digital asset using a first password, the trackable digital asset being encrypted according to one or more embodiments of the method disclosed above. The method further comprises encrypting at least one portion of the decrypted first encrypted trackable digital asset using a second password, thereby generating a second encrypted trackable digital asset. The method further comprises providing at least one indication of the second encrypted trackable digital asset to at least one of a smart contract, a system manager, a server, a processing device, a storage device, a software, a computing node, a blockchain and the like. The method further comprises updating the at least one indication of the first encrypted trackable digital asset with the at least one indication of the second encrypted trackable digital asset.

In one or more embodiments of a method for updating an encrypted trackable digital asset, the method further comprises embedding data suitable for identifying the given event in at least one of the obtained and decrypted first encrypted trackable digital asset, the second encrypted trackable digital asset, at least one of at least one thumbnail of the obtained and decrypted first encrypted trackable digital asset, an obtained thumbnail of the obtained digital asset and at least one thumbnail of a decrypted second encrypted trackable digital asset. In one or more embodiments, the method for updating an encrypted trackable digital asset further comprises at least one of updating the at least one one-way cryptographic encryption of at least one portion of the trackable digital asset and providing at least one one-way cryptographic encryption associated with the trackable digital asset.

In one or more embodiments of a method for updating an encrypted trackable digital asset, the providing of the at least one indication of the second encrypted trackable digital asset further comprises decrypting the second encrypted trackable digital asset and authenticating the decrypted second encrypted trackable digital asset.

It will be appreciated that “trading”, “buying” and “purchasing” a trackable digital asset relate to similar circumstances.

In one or more embodiments of a method for updating an encrypted trackable digital asset, the second password is the first password.

In one or more embodiments, the updating consists of updating data embedded in the encrypted trackable digital asset, without decrypting the encrypted trackable digital asset.

In one or more embodiments, a plurality of encrypted trackable digital assets, once decrypted, may be combined to provide a trackable digital asset.

It will be appreciated that while there is disclosed herein a method for trading an encrypted trackable digital asset, the purpose of one or more embodiment of the methods disclosed herein is to trade a trackable digital asset.

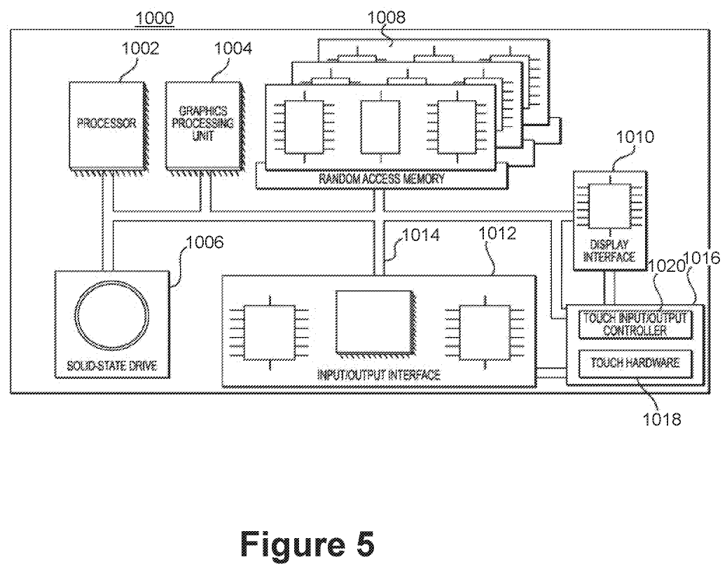

Referring to FIG. 5, there is shown an electronic device 1000 suitable for use with some implementations of the present technology, the buyer and the seller, the electronic device 1000 comprising various hardware components including one or more single or multi-core processors collectively represented by processor 1002, a graphics processing unit (GPU) 1004, a storage device such as a solid-state drive 1006, a random-access memory 1008, a display interface 1010, and an input/output interface 1012.

Communication between the various components of the electronic device 1000 may be enabled by one or more internal and/or external buses 1014 (e.g., a PCI bus, universal serial bus, IEEE 1394 “Firewire” bus, SCSI bus, Serial-ATA bus, etc.), to which the various hardware components are electronically coupled.

The input/output interface 1012 may be coupled to a touchscreen 1016 and/or to the one or more internal and/or external buses 1014. The touchscreen 1016 may be portion of the display. In one or more embodiment, the touchscreen 1016 is the display. The touchscreen 1016 may equally be referred to as a screen 1016. In the embodiments illustrated in FIG. 1, the touchscreen 1016 comprises touch hardware 1018 (e.g., pressure-sensitive cells embedded in a layer of a display allowing detection of a physical interaction between a user and the display) and a touch input/output controller 1020 allowing communication with the display interface 1010 and/or the one or more internal and/or external buses 1014. In one or more embodiment, the input/output interface 1012 may be connected to a keyboard (not shown), a mouse (not shown) or a trackpad (not shown) allowing the user to interact with the electronic device 1000 in addition or in replacement of the touchscreen 1016.

According to implementations of the present technology, the solid-state drive 1006 stores program instructions suitable for being loaded into the random-access memory 1008 and executed by the processor 1002 and/or the GPU 1004 for processing a digital asset. For example, the program instructions may be a portion of a library or an application.

The electronic device 1000 may be implemented as a server, a desktop computer, a laptop computer, a tablet, a smartphone, a personal digital assistant or any device that may be configured to implement the present technology, as it may be understood by a skilled addressee.

There is disclosed a non-transitory computer readable medium for storing instructions that are executable by one or more processors and which when executed perform a method for providing a trackable digital asset, the method comprising obtaining a digital asset to be provided, embedding data suitable for identifying the digital asset in the digital asset to generate a trackable digital asset, obtaining at least one one-way cryptographic encryption of at least one portion of the trackable digital asset, encrypting, using a password, at least one portion of the trackable digital asset, and providing the encrypted trackable digital asset, wherein authenticity of a given digital asset is achieved by comparing the obtained at least one one-way cryptographic encryption of the at least one portion of the trackable digital asset with at least one one-way cryptographic encryption of at least one portion of the given digital asset.

There is further disclosed a computer comprising a central processing unit, a display device, a communication port, a memory unit comprising an application for providing a trackable digital asset, the application comprising instructions for obtaining a digital asset, instructions for embedding data suitable for identifying the digital asset in the digital asset to generate a trackable digital asset, instructions for obtaining at least one indication of at least one one-way cryptographic encryption of at least one portion of the trackable digital asset, instructions for encrypting, using a password, at least one portion of the trackable digital asset, and instructions for providing the at least one indication of the encrypted trackable digital asset, and a data bus for interconnecting the central processing unit, the display device, the communication port and the memory unit.

It will be appreciated that one or more embodiments of the systems and the methods disclosed herein are of great advantages for various reasons.

A first advantage of one or more embodiments of the methods and the systems disclosed herein is that the present technology enables preserving the authenticity of a digital asset when trading thereof, thus enabling the trading of digital assets similarly to the trading of physical assets, thereby adding value to the digital assets. For instance, a person purchasing a digital asset which is known to be authentic will tend to give a greater value to the digital asset than if the authenticity cannot be established or confirmed. Further, the fact that the digital asset is trackable encourages buyers and artists to join a system using trackable digital assets. Furthermore, knowing that a digital asset is authentic and that the digital asset has been indeed originally created by its creator prevent the trade of fraudulent digital assets.

A second advantage of one or more embodiments of the methods and the systems disclosed herein is that encrypting the trackable digital asset and/or the password to encrypt the trackable digital asset enables to secure a digital transfer while minimizing a risk of theft. In addition, because of data embedded in the digital asset and at least one one-way cryptographic encryption of at least one portion of the trackable digital asset, if at least one of the digital asset and the trackable digital asset is leaked by a buyer and/or a seller, malicious individuals will be unable to claim ownership of the at least one of the digital asset and the trackable digital asset.

A third advantage of one or more embodiments of the methods and the systems disclosed herein is that it is possible to track digital assets with the data embedded therein, thus possibly enabling imposing limitations on the use and trade of trackable digital assets, such as, and without being limited to, preventing the trackable digital assets to be stored in determined databases or prohibiting the trade of non-trackable digital assets and/or trackable digital assets in determined blockchains or marketplaces.

A fourth advantage of one or more embodiments of the methods and the systems disclosed herein is that it is possible to decrypt an encrypted trackable digital asset without a user having to remember a password that encrypts the trackable digital asset, since an identifier encrypting the password may be automatically used to recover the password and therefore enables to decrypt the encrypted trackable digital asset without having the user to provide the password, in accordance with one or more embodiment.

The embodiments described above are intended to be exemplary only. The scope of the invention is therefore intended to be limited solely by the appended claims.

1. A computer-implemented method for providing a trackable digital asset, the computer-implemented method comprising:
obtaining a digital asset;
embedding data suitable for identifying the digital asset in at least one portion of the digital asset to generate the trackable digital asset;
obtaining at least one indication of at least one one-way cryptographic encryption of at least one portion of the trackable digital asset;
encrypting, using a password, at least one portion of the trackable digital asset; and
providing at least one indication of at least the encrypted at least one portion of the trackable digital asset,
wherein an authenticity of a given digital asset is determined by comparing the obtained at least one indication of the at least one one-way cryptographic encryption of the at least one portion of the trackable digital asset with at least one indication of at least one one-way cryptographic encryption of at least one portion of the given digital asset.

2. The computer-implemented method as claimed in claim 1, wherein the digital asset comprises at least one element, wherein each of the at least one element is selected from a group consisting of an image file, a video file, an audio file, a text document, binary data and a compressed archive.

3. The computer-implemented method as claimed in any one of claims 1 to 2, wherein said embedding of the data in the at least one portion of the digital asset is performed by combining at least one portion of said data with at least a portion of said digital asset.

4. The computer-implemented method as claimed in any one of claims 1 to 3, wherein said embedding of the data in the at least one portion of the digital asset is performed using at least one steganography technique.

5. The computer-implemented method as claimed in any one of claims 1 to 4, wherein the at least one one-way cryptographic encryption of the at least one portion of the trackable digital asset is performed using at least one hashing technique.

6. The computer-implemented method as claimed in any one of claims 1 to 5, wherein said encrypting of the at least one portion of the trackable digital asset is performed using one of an asymmetric encryption and a symmetric encryption.

7. The computer-implemented method as claimed in any one of claims 1 to 6, wherein the at least one indication of the at least one one-way cryptographic encryption of the at least one portion of the trackable digital asset is a plurality of indications of at least one one-way cryptographic encryption, each indication of at least one one-way cryptographic encryption associated with a corresponding portion of the trackable digital asset, wherein the authenticity of the given digital asset is determined by comparing the obtained plurality of indications of at least one one-way cryptographic encryption of the given digital asset with a corresponding plurality of indications of at least one one-way cryptographic encryptions of the trackable digital asset.

8. The computer-implemented method as claimed in any one of claims 1 to 7, wherein said providing of the at least one indication of at least the encrypted at least one portion of the trackable digital asset further comprises providing the obtained at least one indication of the at least one one-way cryptographic encryption of the at least one portion of the trackable digital asset.

9. The computer-implemented method as claimed in any one of claims 1 to 7, wherein said providing of the at least one indication of at least the encrypted at least one portion of the trackable digital asset further comprises at least one of:
minting at least one of the at least one indication of at least the encrypted at least one portion of the trackable digital asset and the obtained at least one indication of the at least one one-way cryptographic encryption of the at least one portion of the trackable digital asset in a blockchain; and
providing at least one of the at least one indication of at least the encrypted at least one portion of the trackable digital asset and the obtained at least one indication of the at least one one-way cryptographic encryption of the at least one portion of the trackable digital asset to at least one of a smart contract, a system manager, a server, a computing node, a processing device, a software and a storage device.

10. The computer-implemented method as claimed in claim 9, further comprising providing the obtained at least one indication of the at least one one-way cryptographic encryption of the trackable digital asset to at least one of a smart contract, a system manager, a server, a computing node, a processing device, a software and a storage device.

11. The computer-implemented method as claimed in any one of claims 1 to 10, wherein at least one of said obtaining of the digital asset, said embedding of the data in the at least one portion of the digital asset, said obtaining of the at least one indication of the at least one one-way cryptographic encryption of the at least one portion of the trackable digital asset; said encrypting of the at least one portion of the trackable digital asset and said providing of the at least one indication of at least the encrypted at least one portion of the trackable digital asset is performed by at least one of a smart contract, a computing node, a server, a processing device, a software, a storage device and a system manager.

12. The computer-implemented method as claimed in any one of claims 1 to 11, wherein at least one of said obtaining of the at least one indication of the at least one one-way cryptographic encryption of at least one portion of the trackable digital asset and said encrypting at least one portion of the trackable digital asset is performed on a totality of the trackable digital asset.

13. The computer-implemented method as claimed in any one of claims 1 to 12, further comprising:
obtaining at least one thumbnail representing at least one of the digital asset and the trackable digital asset; and
providing at least one indication of the obtained at least one thumbnail.

14. The computer-implemented method as claimed in claim 13, wherein said obtaining of the at least one thumbnail further comprises embedding additional data in at least one portion of the at least one thumbnail.

15. The computer-implemented method as claimed in any one of claims 1 to 14, wherein said obtaining of the digital asset comprises digitalizing an asset.

16. The computer-implemented method as claimed in any one of claims 1 to 15, wherein said providing of the at least one indication of at least the encrypted at least one portion of the trackable digital asset further comprises transforming the at least one indication of at least the encrypted at least one portion of the trackable digital asset into an encrypted trackable asset.

17. The computer-implemented method as claimed in any one of claims 1 to 16, wherein the trackable digital asset is an encrypted trackable digital asset.

18. The computer-implemented method as claimed in claim 13 or 14, further comprising:
obtaining at least one identifier for identifying at least one given computing node, the at least one given computing node being associated with said encrypting of the at least one portion of the trackable digital asset; and
obtaining an encrypted password using at least one portion of the obtained at least one identifier.

19. The computer-implemented method as claimed in claim 18, wherein said obtaining of said at least one identifier for identifying said at least one given computing node further comprises generating at least one portion of at least one recovery identifier associated with at least one portion of the obtained at least one identifier.

20. The computer-implemented method as claimed in any one of claims 1 to 19, further comprising:
encrypting, using the password, the at least one indication of the encrypted at least one portion of the trackable digital asset; and
providing the encrypted at least one indication of the encrypted at least one portion of the trackable digital asset.

21. A computer-implemented method for trading at least one of an ownership of and an access to the trackable digital asset between a buyer and a seller, the computer-implemented method comprising:
organizing a transaction between a buyer and a seller to purchase the at least one of the ownership of and the access to the trackable digital asset, the trackable digital asset being generated according to the computer-implemented method as claimed in any one of claims 1 to 20; and
authenticating the trackable digital asset using the at least one indication of the at least one one-way cryptographic encryption of at least one portion of the trackable digital asset.

22. The computer-implemented method as claimed in claim 21, further comprising providing at least one asset to the seller.

23. The computer-implemented method as claimed in claim 22, wherein:
said providing of the password further comprises providing the password to at least one first computing node; and
said providing of the at least one asset further comprises providing the at least one asset to at least one second computing node,
wherein the at least one second computing node is configured for transferring the at least one asset from the buyer to the seller and the at least one first computing node is configured for transferring the password from the seller to the buyer once the at least one asset is received at the at least one second computing node and the password is received at the at least one first computing node.

24. The computer-implemented method as claimed in claim 23, wherein the at least one second computing node is the at least one first computing node.

25. A computer-implemented method for trading at least one of an ownership of and an access to the trackable digital asset between a buyer and a seller, the computer-implemented method comprising:
organizing a transaction between a buyer and a seller to purchase the at least one of the ownership of and the access to the trackable digital asset, the trackable digital asset being generated according to the computer-implemented method as claimed in claim 19; and
authenticating the trackable digital asset using the at least one indication of the at least one one-way cryptographic encryption of the at least one portion of the trackable digital asset.

26. The computer-implemented method as claimed in claim 25, further comprising providing at least one asset to the seller.

27. The computer-implemented method as claimed in claim 26, further comprising providing an indication of the encrypted password and at least one of the at least one portion of the at least one identifier and the at least one portion of the at least one recovery identifier to the buyer.

28. The computer-implemented method as claimed in claim 27, wherein:
said providing of the indication of the encrypted password and at least one of the at least one portion of the at least one identifier and the at least one portion of the at least one recovery identifier further comprises providing the indication of the encrypted password and at least one of the at least one portion of the at least one identifier and the at least one portion of the at least one recovery identifier to at least one third computing node; and
said providing of the at least one asset further comprises providing the at least one asset to at least one fourth computing node,
wherein the at least one fourth computing node is configured for transferring the at least one asset from the buyer to the seller and the at least one third computing node is configured for transferring the indication of the encrypted password and at least one of the at least one portion of the at least one identifier and the at least one portion of the at least one recovery identifier from the seller to the buyer once the at least one asset is received at the at least one fourth computing node and the indication of the encrypted password and the at least one of the at least one portion of the at least one identifier and the at least one portion of the at least one recovery identifier are received at the at least one third computing node.

29. The computer-implemented method as claimed in claim 28, wherein the at least one fourth computing node is the at least one third computing node.

30. The computer-implemented method as claimed in claim 29, wherein one of the indication of the encrypted password and the at least one of the at least one portion of the at least one identifier and the at least one portion of the at least one recovery identifier is provided prior to the at least one asset being received at the at least one fourth computing node.

31. The computer-implemented method as claimed in claim 30, wherein said organizing of the transaction comprises one of organizing at least one of a bidding process, a buying process, a trading process and an offering process to complete the transaction between the buyer and the seller and providing at least one condition to meet to complete said transaction between the buyer and the seller.

32. A computer-implemented method for determining an authenticity of a given digital asset to authenticate, the computer-implemented method comprising:
obtaining the given digital asset to authenticate and the at least one indication of the at least one one-way cryptographic encryption of at least one portion of a trackable digital asset, the at least one indication of the at least one one-way cryptographic encryption of the at least one portion of the trackable digital asset being obtained according to the computer-implemented method as claimed in any one of claims 1 to 19;
obtaining at least one indication of at least one one-way cryptographic encryption of at least one portion of the given digital asset to authenticate;
obtaining an indication of a comparison between the at least one indication of the at least one one-way cryptographic encryption of the at least one portion of the trackable digital asset and the obtained at least one indication of the at least one one-way cryptographic encryption of the at least one portion of the given digital asset to determine its authenticity; and
providing the indication of the comparison.

33. A computer-implemented method for at least updating at least one indication of a first encrypted trackable digital asset, the computer-implemented method comprising:
in response to a given event, obtaining and decrypting the first encrypted trackable digital asset using the password, the trackable digital asset being encrypted according to the computer-implemented method as claimed in claim 19;
encrypting at least one portion of the decrypted first encrypted at least one portion of the trackable digital asset using a second password, thereby generating a second encrypted trackable digital asset;
providing at least one indication of the second encrypted trackable digital asset to at least one of a smart contract, a system manager, a server, a processing device, a software a storage device, a computing node and a blockchain; and
updating the at least one indication of the first encrypted at least one portion of the trackable digital asset with the at least one indication of the second encrypted trackable digital asset.

34. The computer-implemented method as claimed in claim 33, further comprising embedding data suitable for identifying said given event in at least one portion of at least one of the obtained and decrypted first encrypted at least one portion of the trackable digital asset, the second encrypted trackable digital asset, the at least one thumbnail and at least one thumbnail of a decrypted second encrypted trackable digital asset.

35. The computer-implemented method as claimed in claim 34, wherein the second password is the password.

36. The computer-implemented method as claimed in any one of claims 33 to 35, wherein said providing of the at least one indication of the second encrypted trackable digital asset further comprises decrypting the second encrypted trackable digital asset and authenticating the decrypted second encrypted trackable digital asset.

37. The computer-implemented method as claimed in claim 36, wherein said decrypting the second encrypted trackable digital asset further comprises decrypting the encrypted password with at least one of the at least one portion of the at least one identifier and the at least one portion of the at least one recovery identifier.

38. A computer-implemented method for at least updating at least one indication of a third encrypted trackable digital asset, the computer-implemented method comprising:
in response to a given event, obtaining the third encrypted trackable digital asset, the third trackable digital asset being encrypted according to the computer-implemented method as claimed in any one of claims 1 to 32;
embedding additional data suitable for identifying said given event in the third encrypted at least one portion of the trackable digital asset, thereby generating a fourth encrypted trackable digital asset;
providing at least one indication of the fourth encrypted trackable digital asset to at least one of a smart contract, a system manager, a server, a processing device, a software a storage device, a computing node and a blockchain; and
updating the at least one indication of the third encrypted at least one portion of the trackable digital asset with the at least one indication of the fourth encrypted trackable digital asset.

39. The computer-implemented method as claimed in any one of claims 1 to 19, wherein the obtaining of the at least one indication of the at least one one-way cryptographic encryption of at least one portion of the trackable digital asset comprises generating said at least one indication of the at least one one-way cryptographic encryption of at least one portion of the trackable digital asset; and further wherein the authenticity of the given digital asset is determined by comparing the generated at least one indication of the at least one one-way cryptographic encryption of the at least one portion of the trackable digital asset with at least one indication of at least one one-way cryptographic encryption of at least one portion of the given digital asset.

40. The computer-implemented method as claimed in any one of claims 1 to 19, wherein the providing of the at least one indication of at least the encrypted at least one portion of the trackable digital asset comprises providing at least the encrypted at least one portion of the trackable digital asset.

41. A non-transitory computer readable medium for storing instructions that are executable by one or more processors and which when executed perform a method for providing a trackable digital asset, the method comprising:
obtaining a digital asset to be provided;
embedding data suitable for identifying the digital asset in at least one portion of the digital asset to generate the trackable digital asset;
obtaining at least one indication of at least one one-way cryptographic encryption of at least one portion of the trackable digital asset;
encrypting, using a password, at least one portion of the trackable digital asset; and
providing at least one indication of at least the encrypted at least one portion of the trackable digital asset,
wherein an authenticity of a given digital asset is achieved by comparing the obtained at least one indication of the at least one one-way cryptographic encryption of the at least one portion of the trackable digital asset with at least one indication of at least one one-way cryptographic encryption of at least one portion of the given digital asset.

42. A computer comprising:
a central processing unit;
a display device;
a communication port;
a memory unit comprising an application for providing a trackable digital asset, the application comprising:
instructions for obtaining a digital asset;
instructions for embedding data suitable for identifying the digital asset in at least one portion of the digital asset to generate the trackable digital asset;
instructions for obtaining at least one indication of at least one one-way cryptographic encryption of at least one portion of the trackable digital asset;
instructions for encrypting, using a password, at least one portion of the trackable digital asset; and
instructions for providing at least one indication of at least the encrypted at least one portion of the trackable digital asset; and
a data bus for interconnecting the central processing unit, the display device, the communication port and the memory unit.
